(19) United States
(12) Patent Application Publication
(10) Pub. No.: US 2025/0071099 A1
(43) Pub. Date: Feb. 27, 2025

(54) METHOD, APPARATUS AND DEVICE FOR SECURE DATA TRANSMISSION

(71) Applicant: CHINA IWNCOMM CO., LTD., Shaanxi (CN)

(72) Inventors: Jinfa GUO, Shaanxi (CN); Qin LI, Shaanxi (CN); Lulin FAN, Shaanxi (CN)

(21) Appl. No.: 18/724,674

(22) PCT Filed: Dec. 20, 2022
(86) PCT No.: PCT/CN2022/140439

§ 371 Date: Jun. 27, 2024

(30) Foreign Application Priority Data
Jan. 5, 2022 (CN) 202210005672.6

(51) Int. Cl. H04L 9/40

(52) U.S. Cl. CPC H04L 63/0435; H04L 63/06

(57) ABSTRACT

The present application provides a method, apparatus, and device for secure data transmission. The method comprises: a node 1 incrementally updates an SN1 value, performs first mathematical transformation on the updated SN1 value to calculate an IV1, encrypts a first data packet according to the IV1 and a key, and then sends the encrypted first data packet to a node 2; the node 2 acquires the SN1 value in the first data packet, performs the first mathematical transformation on the acquired SN1 value to calculate the IV1, and decrypts the encrypted first data packet by using the IV1 and the key; the node 2 incrementally updates an SN2 value, performs second mathematical transformation on the updated SN2 value to calculate an IV2, encrypts a second data packet according to the IV2 and the key, and sends the encrypted second data packet to the node 1.

### CROSS REFERENCE TO RELATED APPLICATION

The present application is a National Stage of International Application No. PCT/CN2022/140439, filed on Dec. 20, 2022, which claims the priority to Chinese Patent Application No. 202210005672.6, filed with China National Intellectual Property Administration on Jan. 5, 2022, which is incorporated in its entirety herein by reference.

### TECHNICAL FIELD

The present application relates to the field of network communication, and in particular to a method, apparatus and device for data secure transmission.

### BACKGROUND

Internet protocol security (IPSec) provides secure communication between two nodes. Security association (SA), a basis of the IPSec, refers to a set of policies and keys used to protect communication information. An initialization vector (IV), also known as a starting variable (SV), is an input value having a fixed length, and is usually a random number or pseudorandom number.

In the prior art, when the two nodes of the IPSec are enabled for bidirectional communication, the IV is calculated according to a serial number (SN) carried in a data packet, and encryption/decryption of the data packet is jointly completed by the key and an IV value in the SA. The SA is a unidirectional logical connection. For bidirectional communication between the two nodes, it is necessary to establish a pair of SAs, one of which is used for inbound communication, and the other one of which is used for outbound communication. In view of this, a solution using the unidirectional SA has the defect of consuming system resources.

### SUMMARY

The present application provides a method, apparatus and device for data secure transmission, which solve the problem that a solution using a unidirectional security association (SA) consumes system resources in the prior art.

In a first aspect, the present application provides a method for data secure transmission. The method includes: incrementally updating, by a node 1, a serial number SN₁ value initialized by the node 1, and performing, by the node 1, first mathematical transformation on an updated SN₁ value to calculate a first initialization vector IV₁; encrypting, by the node 1, a first data packet according to the calculated IV₁ and a key, and then sending, by the node 1, an encrypted first data packet to a node 2; acquiring, by the node 2, the SN₁ value in the received first data packet, performing, by the node 2, the first mathematical transformation on the acquired SN₁ value to calculate IV₁, and decrypting, by the node 2, the encrypted first data packet according to the calculated IV₁ and the key; incrementally updating, by the node 2, a serial number SN₂ value initialized by the node 2, and performing, by the node 2, second mathematical transformation on an updated SN₂ value to calculate a second initialization vector IV₂; encrypting, by the node 2, a second data packet according to IV₂ and the key, and then sending, by the node 2, an encrypted second data packet to the node 1; and acquiring, by the node 1, the SN₂ value in the received second data packet, performing, by the node 1, the second mathematical transformation on the acquired SN₂ value to calculate IV₂, and decrypting, by the node 1, the encrypted second data packet according to the calculated IV₂ and the key; where the first mathematical transformation and the second mathematical transformation cause the calculated IV₁ to be unequal to the calculated IV₂.

Optionally, before the node 1/node 2 calculates the first initialization vector IV₁, the method further includes: determining an overflow sequence of SN₁ and IV₁; performing the first mathematical transformation on the updated/acquired SN₁ value to calculate IV₁ when it is determined that SN₁ overflows firstly as follows: setting the SN₁ value configured to calculate IV₁ as a first dynamic parameter, multiplying the first dynamic parameter by a coefficient P, and then summing a product of the first dynamic parameter and the coefficient P, a differentiation parameter C and a first parameter Q₁ to calculate IV₁; and performing the first mathematical transformation on the updated/acquired SN₁ value to calculate IV₁ when it is determined that IV₁ overflows firstly as follows: dividing the SN₁ value configured to calculate IV₁ by M for complementation to obtain a third dynamic parameter, multiplying the third dynamic parameter by the coefficient P, and then summing a product of the third dynamic parameter and the coefficient P, the differentiation parameter C and Q₁ to calculate IV₁; where P is unequal to 1 and 0, and Q₁ is 0 or is not an integer multiple of P; and a length of C is equal to a length n of IV₁, C includes higher-order bits of k bits and lower-order bits of n−k bits, a value of the lower-order bits is zero, and M is a maximum value 2^{n-k} of the lower-order n−k bits of IV₁ when IV₁ overflows firstly.

Optionally, the determining the overflow sequence of SN₁ and IV₁ includes: calculating a difference between the length n of IV₁ and a length k of the higher-order bits; determining SN₁ to overflow firstly under a condition that a length m of SN₁ is not greater than the difference; and determining IV₁ to overflow firstly under a condition that the length m of SN₁ is greater than the difference.

Optionally, before the node 2/node 1 calculates the second initialization vector IV₂, the method further includes: determining an overflow sequence of SN₂ and IV₂; performing the second mathematical transformation on the updated/acquired SN₂ value to calculate IV₂ when it is determined that SN₂ overflows firstly as follows: setting the SN₂ value configured to calculate IV₂ as a second dynamic parameter, multiplying the second dynamic parameter by the coefficient P, and then summing a product of the second dynamic parameter and the coefficient P, the differentiation parameter C and a second parameter Q₂ to calculate IV₂; and performing the second mathematical transformation on the updated/acquired SN₂ value to calculate IV₂ when it is determined that IV₂ overflows firstly as follows: dividing the SN₂ value configured to calculate IV₂ by M for complementation to obtain a fourth dynamic parameter, multiplying the fourth dynamic parameter by the coefficient P, and then summing a product of the fourth dynamic parameter and the coefficient P, the differentiation parameter C and Q₂ to calculate IV₂; where Q₂ is 0 or is not an integer multiple of P, and is different from Q₁; and a length of C is equal to a length n of IV₂, and M is a maximum value 2^{n-k} of lower-order n−k bits of IV₂ when IV₂ overflows firstly.

Optionally, the determining an overflow sequence of SN₂ and IV₂ includes: calculating a difference between the length n of IV₂ and a length k of the higher-order bits; determining SN₂ to overflow firstly under the condition that a length m of SN₂ is not greater than the difference; and determining IV₂ to overflow firstly under the condition that the length m of SN₂ is greater than the difference.

Optionally, before the node 1/node 2 calculates the first initialization vector IV₁, the method further includes: starting an updating operation for the key when it is determined that SN₁ overflows firstly and the first dynamic parameter reaches a first preset threshold, and using an updated new key as a key used during data sending when the first dynamic parameter reaches a second preset threshold, where the first preset threshold is less than the second preset threshold, and the second preset threshold is not greater than a maximum value of SN₁; and starting an updating operation for the key when it is determined that IV₁ overflows firstly and the third dynamic parameter reaches a third preset threshold, and using an updated new key as a key used during data sending when the third dynamic parameter reaches a fourth preset threshold, where the third preset threshold is less than the fourth preset threshold, and the fourth preset threshold is not greater than a maximum value of lower-order n−k bits of IV₁.

Optionally, before the node 2/node 1 calculates the second initialization vector IV₂, the method further includes: starting an updating operation for the key when it is determined that SN₂ overflows firstly and the second dynamic parameter reaches a first preset threshold, and using an updated new key as a key used during data sending when the second dynamic parameter reaches a second preset threshold, where the first preset threshold is less than the second preset threshold, and the second preset threshold is not greater than a maximum value of SN₂; and starting an updating operation for the key when it is determined that IV₂ overflows firstly and the fourth dynamic parameter reaches a third preset threshold, and using an updated new key as a key used during data sending when the fourth dynamic parameter reaches a fourth preset threshold, where the third preset threshold is less than the fourth preset threshold, and the fourth preset threshold is not greater than a maximum value of lower-order n−k bits of IV₂.

Optionally, when starting an updating operation for the key, the method further includes: starting a calculation operation of a new value of a number k of bits of the higher-order bits to generate a new differentiation parameter C; or, starting a calculation operation of a new value N of the higher-order bits of the k bits to generate a new differentiation parameter C.

Optionally, when using the updated new key as the key used during data sending, the method further includes: calculating an initialization vector (IV) used during data sending according to the new differentiation parameter C.

Optionally, P is set as 2, Q₁ is set as 0, Q₂ is set as −1, and C is set as a random number.

In a second aspect, the present application provides an apparatus for data secure transmission. The apparatus includes: a first calculation unit, configured to incrementally update a serial number SN₁ value initialized by the apparatus, and perform first mathematical transformation on an updated SN₁ value to calculate a first initialization vector IV₁; a first encryption unit, configured to encrypt a first data packet according to the calculated IV₁ and a key, and then send an encrypted first data packet to a node 2; and a first decryption unit, configured to acquire an SN₂ value in a received second data packet, perform second mathematical transformation on the acquired SN₂ value to calculate a second initialization vector IV₂, and decrypt an encrypted second data packet according to the calculated IV₂ and the key; where the first mathematical transformation and the second mathematical transformation cause the calculated IV₁ to be unequal to the calculated IV₂.

In a third aspect, the present application provides an apparatus for data secure transmission. The apparatus includes: a second decryption unit, configured to acquire an SN₁ value in a received first data packet, perform first mathematical transformation on the acquired SN₁ value to calculate a first initialization vector IV₁, and decrypt an encrypted first data packet according to the calculated IV₁ and a key; a second calculation unit, configured to incrementally update a serial number SN₂ value initialized by the apparatus, and perform second mathematical transformation on an updated SN₂ value to calculate a second initialization vector IV₂; a second encryption unit, configured to encrypt a second data packet according to the calculated IV₂ and the key, and then send an encrypted second data packet to a node 1, where the first mathematical transformation and the second mathematical transformation cause the calculated IV₁ to be unequal to the calculated IV₂.

In a fourth aspect, the present application provides a device for data secure transmission. The device includes a memory and a processor, where the memory is configured to store a computer program; and the processor is configured to read the computer program in the memory and execute steps of the method for data secure transmission at a side of a node 1 or node 2 according to the first aspect above.

In a fifth aspect, the present application provides a computer program medium. The computer program medium stores a computer program, where when the computer program is executed by a processor, steps of the method for data secure transmission at a side of a node 1 or node 2 according to the first aspect above is implemented.

The method, apparatus and device for data secure transmission according to the present application have the following beneficial effects.

According to the solution of the present application, for each data interaction between communication nodes, secret communication can be performed according to different initialization vectors (IVs) and the same key, and the same key can be used for inbound communication and outbound communication on the basis of ensuring communication security. That is, only one SA needs to be established and maintained between the communication nodes. However, in the prior art, a pair of SAs need to be established and maintained between communication nodes in order to ensure communication security, one of which is used for inbound communication, and the other one of which is used for outbound communication. That is, the inbound communication uses one key, and the outbound communication uses another different key. When one node communicates with a large number of nodes, the solution of the present application greatly reduces the number of SAs that need to be established and maintained by the nodes, thereby greatly reducing consumption of system resources.

### BRIEF DESCRIPTION OF FIGURES

FIG. 1 is a schematic diagram of an application scenario of data secure transmission according to an embodiment of the present application.

FIG. 2 is a flow chart of a method for data secure transmission according to an embodiment of the present application.

FIG. 3 is a schematic diagram of a differentiation parameter C according to an embodiment of the present application.

FIG. 4 is a flow chart showing that a node 1/node 2 calculates a first initialization vector IV₁ according to an embodiment of the present application.

FIG. 5 is a flow chart showing that a node 2/node 1 calculates the second initialization vector IV₂ according to an embodiment of the present application.

FIG. 6 is a schematic diagram of data secure transmission having an encapsulation format according to an embodiment of the present application.

FIG. 7 is a schematic diagram of data secure transmission having no encapsulation format according to an embodiment of the present application.

FIG. 8 is a flow chart of data secure transmission having an encapsulation format according to an embodiment of the present application.

FIG. 9 is a flow chart of another data secure transmission having an encapsulation format according to an embodiment of the present application.

FIG. 10 is a schematic diagram of an apparatus for data secure transmission according to an embodiment of the present application.

FIG. 11 is a schematic diagram of another apparatus for data secure transmission according to an embodiment of the present application.

FIG. 12 is a schematic diagram of a device for data secure transmission according to an embodiment of the present application.

### DETAILED DESCRIPTION

The technical solutions in the embodiments of the present application will be clearly and completely described below in combination with the accompanying drawings in the embodiments of the present application. Apparently, the embodiments described are merely some embodiments rather than all embodiments of the present application. On the basis of the embodiments in the present application, all other embodiments obtained by those of ordinary skill in the art without making creative efforts fall within the scope of protection of the present application.

It should be noted that the terms “first”, “second”, etc. in the description and claims of the present application and in the accompanying drawings described above, are used to distinguish similar objects, and not necessarily to describe a particular order or sequential order. It should be understood that the data used in this way can be interchanged where appropriate, such that the embodiments of the present application described herein can be implemented in other sequences than those illustrated or described herein.

The implementations described in the following exemplary embodiments do not denote all implementations consistent with the present application. On the contrary, the implementations are merely examples of a device and a method consistent with some aspects of the present application as detailed in the appended claims. On the basis of the embodiments in the present application, all other embodiments obtained by those of ordinary skill in the art without making creative efforts fall within the scope of protection of the present application.

In the description of the embodiments of the present application, unless otherwise specified, “/” represents or. For example, A/B may represent A or B. In addition, in the description of the embodiments of the present application, “plurality” refers to two or more, and other quantifiers are similar thereto. It should be understood that the preferred embodiments described herein are only used for describing and explaining the present application but are not intended to limit the present application, and the embodiments of the present application and features in the embodiments can be combined with each other without conflict.

In view of the problem that the solution using a unidirectional security association (SA) consumes system resources in the prior art, the present application provides a method, apparatus and device for data secure transmission.

The method, apparatus and device for data secure transmission in the embodiments of the present application will be described below in combination with the accompanying drawings.

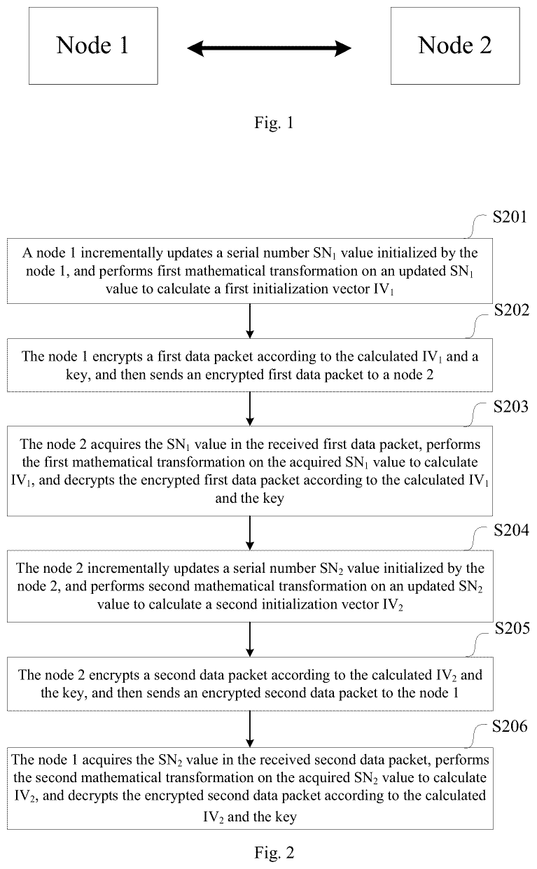

As shown in FIG. 1, a schematic diagram of an application scenario of data secure transmission is provided in an embodiment of the present application, including: a node 1, configured to incrementally update a serial number SN₁ value initialized by the node 1, and perform first mathematical transformation on an updated SN₁ value to calculate a first initialization vector IV₁; encrypt a first data packet according to the calculated IV₁ and a key, and then send an encrypted first data packet to a node 2; and acquire an SN₂ value in a received second data packet, perform second mathematical transformation on the acquired SN₂ value to calculate a second initialization vector IV₂, and decrypt an encrypted second data packet according to the calculated IV₂ and the key; and the node 2, configured to acquire an SN₁ value in the received first data packet, perform the first mathematical transformation on the acquired SN₁ value to calculate IV₁, and decrypt the encrypted first data packet according to the calculated IV₁ and the key; incrementally update a serial number SN₂ value initialized by the node 2, and perform second mathematical transformation on an updated SN₂ value to calculate a second initialization vector IV₂; and encrypt a second data packet according to the calculated IV₂ and the key, and then send an encrypted second data packet to the node 1.

The encrypted first data packet at least includes an SN₁ value field and an encrypted data field. The encrypted second data packet at least includes an SN₂ value field and an encrypted data field. The first mathematical transformation and the second mathematical transformation cause the calculated IV₁ to be unequal to the calculated IV₂.

It should be noted that both communication parties are represented by the node 1 and the node 2. When secure communication is provided between the two nodes, the node 1 may be a local requester (which is abbreviated as a local REQ) or a peer responder (which is abbreviated as a peer REP). When the node 1 acts as the local REQ, the node 2 is the peer REP. When the node 1 acts as the peer REP, the node 2 is the local REQ.

The node 1 and the node 2 may be network devices in any form, such as routers, gateways, switches, network bridges, wireless access points, base stations, firewalls, modems, hubs, network interface controllers (NICs), reverse proxy, servers (e.g., proxy servers), multiplexers, security devices, intrusion detection devices, load balancers and similar devices, etc.; or may also be cellular networks, local area networks (LANs), core networks, access networks, wide area networks (WANs) such as Internet, cloud networks, etc., which are not limited in the embodiment of the present application.

Communication between the node 1 and the node 2 may include data secure transmission having an encapsulation format or data secure transmission having no encapsulation format.

As shown in FIG. 2, a flow chart of a method for data secure transmission is provided in an embodiment of the present application. The method includes the following.

S201, a node 1 incrementally updates a serial number SN₁ value initialized by the node 1, and performs first mathematical transformation on an updated SN₁ value to calculate a first initialization vector IV₁.

The meaning that the node 1 incrementally updates the serial number SN₁ value initialized by the node 1 is as follows: after the node 1 initializes the SN₁ value, the node 1 incrementally updates the SN₁ value initialized; and the node 1 incrementally updates the SN₁ value used last time when calculating IV₁ next time.

A value from which the SN₁ value starts, and a specific form of incremental updating of the SN₁ value are not limited in the embodiment of the present application. As an optional implementation, the SN₁ value starts from 1 and is incrementally updated by adding 1 each time.

An initial value of SN₁ is not limited in the embodiment of the present application, and the initial value of SN₁ may be extremely large. In an extreme case, the initial value of SN₁ is a set key updating critical value. The extreme case is within the scope of protection of the embodiment of the present application.

S202, the node 1 encrypts a first data packet according to the calculated IV₁ and a key, and then sends an encrypted first data packet to a node 2.

By using the calculated IV₁ and the key as two input parameters of an encryption algorithm used, the first data packet is encrypted according to the encryption algorithm used, and then an encrypted first data packet is sent to the node 2. The encrypting the first data packet includes: encrypting effective loads in the first data packet. The encrypted first data packet at least includes an SN₁ value field and an encrypted data field.

S203, the node 2 acquires the SN₁ value in the received first data packet, performs the first mathematical transformation on the acquired SN₁ value to calculate IV₁, and decrypts the encrypted first data packet according to the calculated IV₁ and the key.

The node 2 receives the encrypted first data packet sent by the node 1, acquires an SN₁value in the encrypted first data packet, and then performs the first mathematical transformation on the acquired SN₁ value to calculate IV₁. Since bidirectional SA is used during communication between the node 1 and the node 2 in the present application, both communication parties only need to establish one SA (the SA includes the key in the embodiment of the present application). Thus, the node 2 may decrypt, by using the calculated IV₁ and the key as two input parameters of the encryption algorithm used, the encrypted first data packet by using the encryption algorithm used.

S204, the node 2 incrementally updates a serial number SN₂ value initialized by the node 2, and performs second mathematical transformation on an updated SN₂ value to calculate a second initialization vector IV₂.

The meaning that the node 2 incrementally updates the serial number SN₂ value initialized by the node 2 is as follows: after the node 2 initializes the SN₂ value, the node 2 incrementally updates the SN₂ value initialized; and the node 2 incrementally updates the SN₂ value used last time when calculating IV₂ next time.

A value from which SN₂ starts, and a specific form of incremental updating of the SN₂ value are not limited in the embodiment of the present application. As an optional implementation, the SN₂ value starts from 1 and is incrementally updated by adding 1 each time.

An initial value of SN₂ is not limited in the embodiment of the present application, and the initial value of SN₂ may be extremely large. In an extreme case, the initial value of SN₂ is a set key updating critical value. The extreme case is within the scope of protection of the embodiment of the present application.

It should be noted that the initial value of SN₂ may be the same as or different from the initial value of SN₁, and the specific form of incremental updating of SN₂ may be the same as or different from the specific form of incremental updating of SN₁.

The first mathematical transformation and the second mathematical transformation cause the calculated IV₁ to be unequal to the calculated IV₂.

S205, the node 2 encrypts a second data packet according to the calculated IV₂ and the key, and then sends an encrypted second data packet to the node 1.

By using the calculated IV₂ and the key as two input parameters of an encryption algorithm used, the second data packet is encrypted according to the encryption algorithm used, and then an encrypted second data packet is sent to the node 1. The encrypting the second data packet includes: encrypting effective loads in the second data packet. The encrypted second data packet at least includes an SN₂ value field and an encrypted data field.

S206, the node 1 acquires the SN₂ value in the received second data packet, performs the second mathematical transformation on the acquired SN₂ value to calculate IV₂, and decrypts the encrypted second data packet according to the calculated IV₂ and the key.

The node 1 receives the encrypted second data packet sent by the node 2, acquires the SN₂ value in the encrypted second data packet, then performs the second mathematical transformation on the acquired SN₂ value to calculate IV₂, and decrypts, by using the calculated IV₂ and the key as two input parameters of the encryption algorithm used, the encrypted second data packet by using the encryption algorithm used.

It should be noted that the first mathematical transformation and the second mathematical transformation are pre-shared between the node 1 and the node 2 in each embodiment of the present application. Moreover, SA consists of a plurality of security association parameters (SAPs). The SAPs include a key parameter. The key parameter is negotiated between the node 1 and the node 2 during establishment of the SA. That is, the key is also pre-shared between the node 1 and the node 2 in each embodiment of the present application.

In the embodiment of the present application, the length of the serial number SN₁ initialized by the node 1 is equal to the length of the serial number SN₂ initialized by the node 2. The length of the first initialization vector IV₁ calculated by the node 1 is equal to the length of the second initialization vector IV₂ calculated by the node 2.

With continuous improvement of computer performance, calculation power of a computer has been rapidly increased. A 64-bit counter, such as an electronic serial number (ESN) of Internet protocol security (IPsec), can quickly overflow in an ultra-high-speed device, and a system will cycle the counter continuously, thereby affecting system performance. In some environments, such as Internet of Things (IOT), the requirements for the counter are not high. A 16-bit counter can satisfy the requirements. However, at least 32-bit SN is to be transmitted in each sent message of the IPsec. Such a design will waste a bandwidth in an environment of receiving and sending rare packets. Thus, in order to be adapted to different application scenarios, an adjustable counter is needed.

Thus, the solution of setting lengths of an SN₁ and an SN₂ according to specific implementation conditions is provided in an embodiment of the present application. The length of both SN₁ and SN₂ may be determined to be m bits according to an application scenario between the node 1 and the node 2. A longer serial number length is set under the condition of high requirements for the counter, so as to solve the problem that the counter overflows quickly in an ultra-high-speed environment. A shorter serial number length is set under the condition of low requirements for the counter, so as to reduce bandwidth traffic, improve bandwidth utilization, and satisfy the requirements for working in some low traffic environments.

For example, in the low traffic environment, the length of both SN₁ and SN₂ is set to 8 bits, and may save 24 bits of bandwidth and traffic compared with SN₁ and SN₂ having a length of 32 bits.

During data secure communication, both communication parties can obtain SN values from each other.

According to the encryption algorithm used, the length of both IV₁ and IV₂ is determined to be n bits between the node 1 and the node 2. The length of IV₁ and IV₂ is determined according to the encryption algorithm used by both communication parties during data secure communication. For example, when the encryption algorithm used by the node 1 and the node 2 is SM4-GCM-128, an IV length is 128 bits. When the encryption algorithm used by the node 1 and the node 2 is AES-GCM-256, the IV length is 256 bits. When the encryption algorithm used by the node 1 and the node 2 is AES-CBC-128, the IV length is 128 bits.

It should be noted that the encryption algorithm may be selected according to specific implementation scenarios, which is not limited in the embodiment of the present application.

As an optional implementation, the encryption algorithm is a symmetric encryption algorithm.

It should be noted that the length m of SN₁ and SN₂, and the length n of IV₁ and IV₂ can be determined by either the node 1 or the node 2, or jointly determined by the node 1 and the node 2.

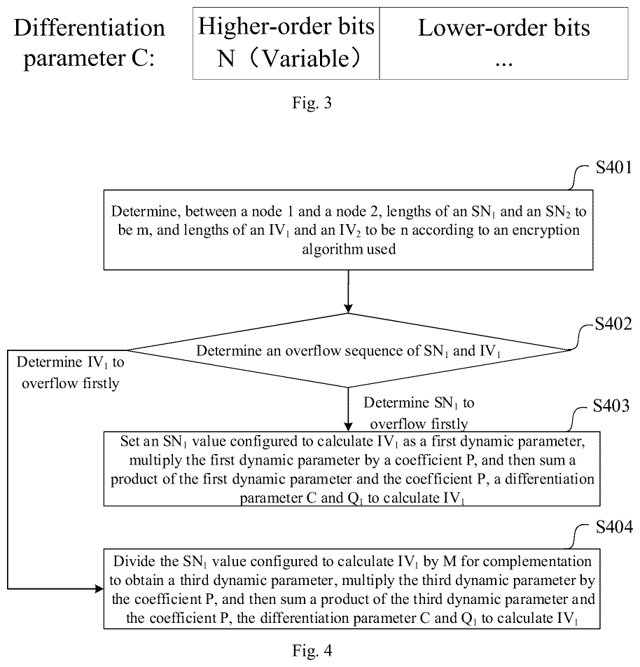

As shown in FIG. 3, a schematic diagram of a differentiation parameter C is provided in an embodiment of the present application. Optionally, the differentiation parameter C may be used as a parameter for calculating an IV value.

A length of C is equal to a length n of IV₁, C includes higher-order bits of k bits and lower-order bits of n−k bits, a value of the lower-order bits is zero, a value N of the higher-order bits is non-zero, and k is a positive integer not less than 1 and less than n.

As an optional implementation, the value N of the higher-order bits of C is determined as follows: the value N of the higher-order bits of C is determined in a random mode; or the value N of the higher-order bits of C is determined according to setting information; or the value N of the higher-order bits of C is determined according to an encryption key; or the value N of the higher-order bits of C is determined by means of key negotiation.

The value N may include (1) a fixed value determined according to the setting information, for example, 0x5C365C36, which ensures that 0 and 1 on the bits are balanced as much as possible and distributions of 0 and 1 are sufficiently disordered; (2) a random number determined in a random mode; (3) part of the encryption key determined according to the encryption key; or (4) a certain part of the value determined by means of key negotiation.

When the value N includes (2), (3) or (4), not all of the value N may be 0xFFFFFFFF or a value proximate to 0xFFFFFFFF. That is, not all bit values of the value N may be 1 or a value proximate to 1, and otherwise a key updating frequency is higher.

A length k of the value N is variable, but the length k of the value N is less than the length of C.

As shown in FIG. 4, a flow chart showing that a node 1/node 2 calculates a first initialization vector IV₁ is provided in an embodiment of the present application. First mathematical transformation used during calculation of IV₁ includes a coefficient P, a first parameter Q₁ and a differentiation parameter C. The step that a node 1/node 2 calculates IV₁ includes the following.

S401, lengths of an SN₁ and an SN₂ are determined to be m between the node 1 and the node 2, and lengths of an IV₁ and an IV₂ are determined to be n according to the encryption algorithm used.

Specific determination processes of the length m and the length n are as described above, which will not be repeated herein.

S402, an overflow sequence of SN₁ and IV₁ is determined.

As an optional implementation, determining an overflow sequence of SN₁ and IV₁ includes: calculating a difference between the length n of IV₁ and a length k of the higher-order bits; determining SN₁ to overflow firstly under the condition that a length m of SN₁ is not greater than the difference; and determining IV₁ to overflow firstly under the condition that the length m of SN₁ is greater than the difference.

The length of the SN₁ is m bits, the length of the IV₁ is n bits, and the length of N is k bits. m, n, and k are integer multiples of 8.

S403, an SN₁ value configured to calculate IV₁ is set as a first dynamic parameter, the first dynamic parameter is multiplied by a coefficient P, and then a product of the first dynamic parameter and the coefficient P, a differentiation parameter C and Q₁ sum up to calculate IV₁ when it is determined that SN₂ overflows firstly.

When m<=n−k, for example, when m=32 bits, n=128 bits, and k=32 bits, a calculation mode of the first initialization vector IV₁ is as follows: IV₁=C+SN₁×P+Q₁. P is unequal to 1 and 0, and Q₁ is 0 or is not an integer multiple of P.

S404, the SN₁ value configured to calculate IV₁ is divided by M for complementation to obtain a third dynamic parameter, the third dynamic parameter is multiplied by the coefficient P, and then a product of the third dynamic parameter and the coefficient P, the differentiation parameter C and Q₁ sum up to calculate IV₁ when it is determined that IV₁ overflows firstly.

When m>n−k, for example, when m=128 bits, n=64 bits, and k=32 bits, a calculation mode of the first initialization vector IV₁ is as follows: IV₁=C+SN₁ %2^{n-k}×P+Q₁. P is unequal to 1 and 0, and Q₁ is 0 or is not an integer multiple of P.

M is a maximum value 2^{n-k} that may be represented by the lower-order n−k bits of IV₁ when IV₁ overflows firstly. The third dynamic parameter is SN₁ %2^{n-k}, and represents complementation between the SN₁ value and 2^{n-k}.

SN₁ %2^{n-k} represents that the value of the third dynamic parameter is cyclic from 0 to 2^{n-k}.

It should be noted that when the IV₁ value overflows firstly, the values of the third dynamic parameters are both 1 for two conditions of SN₁=1 and SN₁=2^{n-k}+1. However, IV₁ has overflowed before SN₁+2^{n-k}+1. Thus, the key needs to be updated. When different keys are updated, different C values may further be updated to make the calculated IV₁ values different. Thus, sufficient randomness is ensured, and it is ensured that the IV values in each round of cycle are different, such that design is more secure.

Moreover, even if the calculated IV₁ values in the two conditions of SN₁=1 and SN₁=2^{n-k}+1 are the same, the keys used are different.

As an optional implementation, before the node 1/node 2 calculates the first initialization vector IV₁, the method further includes: starting an updating operation for the key when it is determined that SN₁ overflows firstly and the first dynamic parameter, i.e., an SN₁ value configured to calculate IV₁, reaches a first preset threshold, and using an updated new key as a key used during data sending when it is determined that SN₁ overflows firstly and the first dynamic parameter, i.e., an SN₁ value configured to calculate IV₁, reaches a second preset threshold, where the first preset threshold is less than the second preset threshold, and the second preset threshold is not greater than a maximum value of SN₁; and starting an updating operation for the key when it is determined that IV₁ overflows firstly and the third dynamic parameter, i.e., SN₁ %2^{n-k}, reaches a third preset threshold, and using an updated new key as a key used during data sending when it is determined that IV₁ overflows firstly and the third dynamic parameter, i.e., SN₁ %2^{n-k}, reaches a fourth preset threshold, where the third preset threshold is less than the fourth preset threshold, and the fourth preset threshold is not greater than a maximum value of lower-order n−k bits of IV₁.

It should be noted that the first preset threshold, the second preset threshold, the third preset threshold and the fourth preset threshold may be set to specific values according to specific implementation conditions on the premise of satisfying the size range requirements. For example, it is generally recommended that the first preset threshold is set to 90% of 2^{m}, the second preset threshold is set to 2^{m}−1, the third preset threshold is set to 90% of 2^{n-k}, and the fourth preset threshold is set to 2^{n-k}−1. 2^{m} represents a maximum value that may be represented by SN₁, and 2^{n-k} represents a maximum value that may be represented by the lower-order n−k bits of IV₁ when IV₁ overflows firstly.

For security consideration, the C value may also be replaced while replacing with the new key.

As an optional implementation, when starting an updating operation for the key, the method further includes: starting a calculation operation of a new value of a number k of bits of the higher-order bits to generate a new differentiation parameter C; or, starting a calculation operation of a new value N of the higher-order bits of the k bits to generate a new differentiation parameter C.

The new differentiation parameter C is generated while the updating operation for the key is started. A specific mode of generating the new differentiation parameter C may include: (1) calculating a new value k′ of a number k of bits of the higher-order bits and calculating a new value N of the higher-order bits of k′ bits; or, (2) calculating a new value N of the higher-order bits of k bits without changing a number k of bits of the higher-order bits.

As an optional implementation, when using an updated new key as a key used during data sending, the method further includes: calculating IV₁ used during data sending according to the new differentiation parameter C.
(1) A new key is used as a key used during data sending and simultaneously an initialization vector IV₁ used during data sending is calculated by using the new differentiation parameter C when it is determined that the SN₁ value overflows firstly and the SN₁ value configured to calculate IV₁ reaches a second preset threshold.
(2) The new key is used as a key used during data sending and simultaneously the initialization vector IV₁ used during data sending is calculated by using the new differentiation parameter C when it is determined that the IV₁ value overflows firstly and SN₁ %2^{n-k} reaches a fourth preset threshold.

It should be noted that the value N of the higher-order bits of the differentiation parameter C according to the embodiment of FIG. 3 is non-zero. As another optional implementation, a value N of higher-order bits of a differentiation parameter C may also be zero. In this case, the value of C is zero. That is, in the embodiment of FIG. 4, a calculation mode of the first initialization vector IV₁ is changed to: IV₁=SN₁×P+Q₁ when m<=n−k, where P is unequal to 1 and 0, and Q₁ is 0 or is not an integer multiple of P; and IV₁=SN₁ %2^{n-k}×P+Q₁ when m>n−k, where P is unequal to 1 and 0, and Q₁ is 0 or is not an integer multiple of P. Compared with the condition in which the value N of the higher-order bits of the differentiation parameter C is zero, the condition in which the value N of the higher-order bits of the differentiation parameter C is non-zero can ensure that the calculated IV₁ value has higher randomness, thereby greatly enhancing security of data encryption.

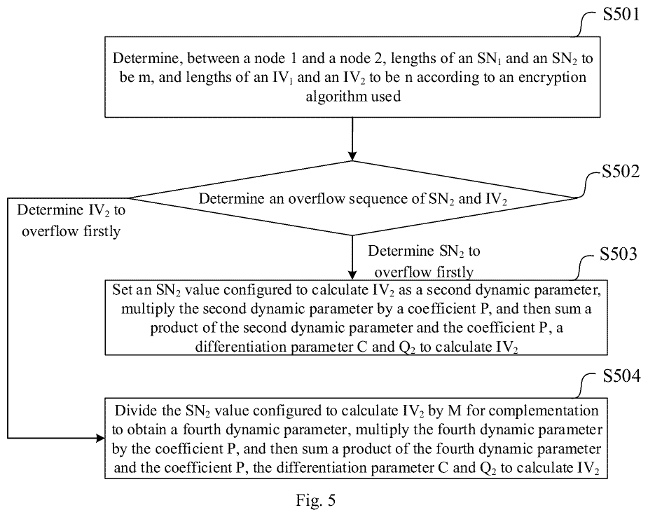

As shown in FIG. 5, a flow chart showing that a node 2/node 1 calculates a second initialization vector IV₂ is provided in an embodiment of the present application. Second mathematical transformation used during calculation of IV₂ includes a coefficient P, a second parameter Q₂ and a differentiation parameter C. The second parameter Q₂ in the second mathematical transformation has a value different from that of a first parameter Q₁ in first mathematical transformation. The step that the node 2/node 1 calculates IV₂ includes the following.

S501, lengths of an SN₁ and an SN₂ are determined to be m between a node 1 and a node 2, and lengths of an IV₁ and an IV₂ are determined to be n according to the encryption algorithm used.

Specific determination processes of the length m and the length n are as described above, which will not be repeated herein.

S502, an overflow sequence of SN₂ and IV₂ is determined.

As an optional implementation, determining an overflow sequence of SN₂ and IV₂ includes: calculating a difference between the length n of IV₂ and a length k of the higher-order bits; determining SN₂ to overflow firstly under the condition that a length m of SN₂ is not greater than the difference; and determining IV₂ to overflow firstly under the condition that the length m of SN₂ is greater than the difference.

The length of SN₂ is m bits, the length of IV₂ is n bits, and the length of N is k bits. Herein, m, n, and k are integer multiples of 8.

S503, an SN₂ value configured to calculate IV₂ is set as a second dynamic parameter, the second dynamic parameter is multiplied by the coefficient P, and then a product of the second dynamic parameter and the coefficient P, the differentiation parameter C and a second parameter Q₂ sum up to calculate IV₂ when it is determined that SN₂ overflows firstly.

When m<=n−k, for example, when m=32 bits, n=128 bits, and k=32 bits, a calculation mode of the second initialization vector IV₂ is as follows: IV₂=C+SN₂×P+Q₂. P is unequal to 1 and 0, Q₂ is 0 or is not an integer multiple of P, and Q₁ is different from Q₂.

S504, the SN₂ value configured to calculate IV₂ is divided by M for complementation to obtain a fourth dynamic parameter, the fourth dynamic parameter is multiplied by the coefficient P, and then a product of the fourth dynamic parameter and the coefficient P, the differentiation parameter C and Q₂ sum up to calculate IV₂ when it is determined that IV₂ overflows firstly.

When m>n−k, for example, when m=128 bits, n=64 bits, and k=32 bits, a calculation mode of the second initialization vector IV₂ is as follows: IV₂=C+SN₂ %2^{n-k}×P+Q₂. P is unequal to 1 and 0, Q₂ is 0 or is not an integer multiple of P, and Q₁ is different from Q₂.

M is a maximum value 2^{n-k} that may be represented by the lower-order n−k bits of IV₂ when IV₂ overflows firstly. The fourth dynamic parameter is SN₂ %2^{n-k}, and represents complementation between the SN₂ value and 2^{n-k}.

SN₂ %2^{n-k} represents that the value of the fourth dynamic parameter is cyclic from 0 to 2^{n-k}−1.

It should be noted that when the IV₂ value overflows firstly, the values of the fourth dynamic parameters are both 1 for two conditions of SN₂=1 and SN₂=2^{n-k}+1. However, IV₂ has overflowed before SN₂=2^{n-k}+1. Thus, the key needs to be updated. When different keys are updated, different C values may further be updated to make the calculated IV₂ values different. Thus, sufficient randomness is ensured, and it is ensured that the IV values in each round of cycle are different, such that design is more secure.

Moreover, even if the calculated IV₂ values in the two conditions of SN₂=1 and SN₂=2^{n-k}+1 are the same, the encryption keys used are different.

As an optional implementation, before the node 2/node 1 calculates the second initialization vector IV₂, the method further includes: starting an updating operation for the key when it is determined that SN₂ overflows firstly and the second dynamic parameter, i.e., an SN₂ value configured to calculate IV₂, reaches a first preset threshold, and using an updated new key as a key used during data sending when t is determined that SN₂ overflows firstly and the second dynamic parameter, i.e., the SN₂ value configured to calculate IV₂, reaches a second preset threshold, where the first preset threshold is less than the second preset threshold, and the second preset threshold is not greater than a maximum value of SN₂; and starting an updating operation for the key when it is determined that IV₂ overflows firstly and the fourth dynamic parameter, i.e., SN₂ %2^{n-k}, reaches a third preset threshold, and using an updated new key as a key used during data sending when it is determined that IV₂ overflows firstly and the fourth dynamic parameter, i.e., SN₂ %2^{n-k}, reaches a fourth preset threshold, where the third preset threshold is less than the fourth preset threshold, and the fourth preset threshold is not greater than a maximum value of lower-order n−k bits of IV₂.

It should be noted that the first preset threshold, the second preset threshold, the third preset threshold and the fourth preset threshold may be set to specific values according to specific implementation conditions on the premise of satisfying the size range requirements. For example, it is generally recommended that the first preset threshold is set to 90% of 2^{m}, the second preset threshold is set to 2^{m}−1, the third preset threshold is set to 90% of 2^{n-k}, and the fourth preset threshold is set to 2^{n-k}−1. Herein, 2^{m} represents a maximum value that may be represented by SN₂, and 2^{n-k} represents a maximum value that may be represented by the lower-order n−k bits of the IV₂ when IV₂ overflows firstly.

For security consideration, the C value may also be replaced while replacing with the new key, and the mode of generating the new differentiation parameter C is the same as that according to the embodiment of FIG. 4, which will not be repeated herein.

As an optional implementation, when using an updated new key as a key used during data sending, the method further includes: calculating an IV₂ used during data sending according to the new differentiation parameter C.
(1) A new key is used as a key used during data sending and simultaneously an initialization vector IV₂ used during data sending is calculated by using the new differentiation parameter C when it is determined that the SN₂ value overflows firstly and the SN₂ value configured to calculate IV₂ reaches a second preset threshold.
(2) The new key is used as a key used during data sending and simultaneously calculate the initialization vector IV₂ used during data sending is calculated by using the new differentiation parameter C when it is determined that the IV₂ value overflows firstly and SN₂ %2^{n-k} reaches a fourth preset threshold.

As an optional implementation, in the embodiments of FIG. 4 and FIG. 5, the node 1 and the node 2 may pre-prepare new C values and new keys. When the key and the C value need to be updated, the node 1 and the node 2 jointly select a new key from the keys pre-prepared as a key used during data sending, and select a new C value from the new C values pre-prepared to calculate the initialization vector (IV) used during data sending.

It should be noted that the value N of the higher-order bits of the differentiation parameter C according to the embodiment of FIG. 3 is non-zero. As another optional implementation, a value N of higher-order bits of a differentiation parameter C may also be zero. In this case, the value of C is zero. That is, in the embodiment of FIG. 5, a calculation mode of the second initialization vector IV₂ is changed to: IV₂=SN₂×P+Q₂ when m<=n−k, where P is unequal to 1 and 0, Q₂ is 0 or is not an integer multiple of P, and Q₂ is different from Q₁; and IV₂=SN₂ %2^{n-k}×P+Q₂ when m>n−k, where P is unequal to 1 and 0, Q₂ is 0 or is not an integer multiple of P, and Q₂ is different from Q₁. Compared with the condition in which the value N of the higher-order bits of the differentiation parameter C is zero, the condition in which the value N of the higher-order bits of the differentiation parameter C is non-zero can ensure that the calculated IV₂ value has higher randomness, thereby greatly enhancing security of data encryption.

The node 1 and the node 2 can communicate by means of a mode of data secure transmission having an encapsulation format, or a mode of data secure transmission having no encapsulation format.

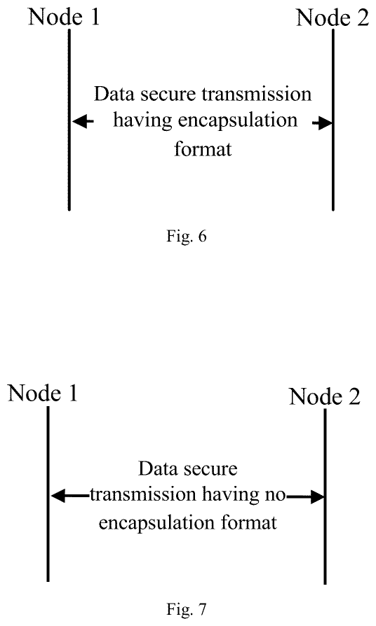

As shown in FIG. 6, a schematic diagram of data secure transmission having an encapsulation format is provided in an embodiment of the present application. It is assumed that communication traffic from a node 1 to a node 2 is DATA₁ₜₒ₂, communication traffic from the node 2 to the node 1 is DATA₂ₜₒ₁, and a key jointly used by the node 1 and the node 2 is Key.

Data traffic interaction between the node 1 and the node 2 executes the following steps.

S1, both communicating parties configure lengths of serial numbers SN₁ and SN₂, and initialize an SN₁ value and an SN₂ value.

S2, the node 1 calculates an IV₁ value according to the length of the SN₁ and the SN₁ value, and the node 2 calculates an IV₂ value according to the length of the SN₂ and the SN₂ value.

For example, the lengths of SN₁ and SN₂ are both m bits, the lengths of IV₁ and IV₂ are both n bits, and a length of higher-order bits of a differentiation parameter C is k bits. m, n, and k are integer multiples of 8. When m=32 bits, n=128 bits, and k=32 bits are taken, m<=n−k, which indicates that SN values of the node 1 and the node 2 overflow firstly. IV₁ of the node 1 is equal to C+SN₁×P+Q₁, where P is unequal to 1 and 0, and Q₁ is 0 or is not an integer multiple of P. IV₂of the node 2 is equal to C+SN₂×P+Q₂, where P is unequal to 1 and 0, Q₂ is 0 or is not an integer multiple of P, and Q₂ is unequal to Q₁.

Each time the node 1 sends a data packet to the node 2, the SN₁ value of the node 1 is incrementally updated. For example, the SN₁ value is updated by adding 1. When the SN₁ value reaches a first preset threshold, an updating operation for the key is started. When the SN₁ value reaches a second preset threshold, an updated new key is used as a key used during data sending.

Each time the node 2 sends a data packet to the node 1, the SN₂ value of the node 2 is incrementally updated. For example, the SN₂ value is updated by adding 1. When the SN₂ value reaches the first preset threshold, an updating operation for the key is started. When the SN₂ value reaches the second preset threshold, an updated new key is used as a key used during data sending.

For another example, when m=128 bits, n=64 bits, and k=32 bits, m>n−k, which indicates that IV values of the node 1 and the node 2 overflow firstly. IV₁ of the node 1 is equal to C+SN₁ %2^{n-k}×P+Q₁, where P is unequal to 1 and 0, and Q₁ is 0 or is not an integer multiple of P. IV₂ of the node 2 is equal to C+SN₂ %2^{n-k}×P+Q₂, where P is unequal to 1 and 0, Q₂ is 0 or is not an integer multiple of P, and Q₂ is unequal to Q₁.

Each time the node 1 sends a data packet to the node 2, the SN₁ value of the node 1 is incrementally updated. Since the IV₁ value overflows before the SN₁ value, when SN₁ %2^{n-k} reaches a third preset threshold, an updating operation for a key is started. When SN₁ %2^{n-k} reaches a fourth preset threshold, an updated new key is used as a key used during data sending.

Each time the node 2 sends a data packet to the node 1, the SN₂ value of the node 2 is incrementally updated. Since the IV₂ value overflows before the SN₂ value, an updating operation for a key is started when SN₂ %2^{n-k} reaches the third preset threshold. When SN₂ %2^{n-k} reaches the fourth preset threshold, an updated new key is used as a key during data sending.

For P, Q₁ and Q₂, preferably P is set as 2, Q₁ is set as 0 and Q₂ is set as −1. The smaller the value is, the less likely IV₁ and IV₂ overflow, and the less a key updating frequency is, and thus performance is better.

Certainly, P, Q₁, and Q₂ may also be set according to specific implementation conditions. For example, P=3, Q₁=2, and Q₂=1 may be set.

S3, traffic on both communication parties is encrypted and decrypted by using the IV₁/IV₂ value calculated and an encryption algorithm.

It should be noted that the node 1 and the node 2 communicate by means of data secure transmission having an encapsulation format. Before the node 1 sends DATA₁ₜₒ₂ to the node 2, the node 1 encrypts DATA₁ₜₒ₂ according to the Key and the calculated IV₁ value in combination with the encryption algorithm, encapsulates encrypted traffic according to an encapsulation protocol, and sends encapsulated traffic to the node 2 after completion. After receiving the encrypted traffic sent by the node 1, the node 2 obtains the SN₁ value from an encapsulated message, and decrypts the encrypted traffic according to the IV₁ value calculated by the node 2 and the Key in combination with the encryption algorithm to obtain DATA₁ₜₒ₂.

Similarly, before the node 2 sends DATA₂ₜₒ₁ to the node 1, the node 2 encrypts DATA₂ₜₒ₁ by using the Key and the calculated IV₂ value in combination with the encryption algorithm, encapsulates encrypted traffic according to an encapsulation protocol, and sends encapsulated traffic to the node 1 after completion. After receiving the encrypted traffic sent by the node 2, the node 1 obtains the SN₂ value from an encapsulated message, and decrypts the encrypted traffic according to the IV₂ value calculated by the node 2 and the Key in combination with the encryption algorithm to obtain DATA₂ₜₒ₁.

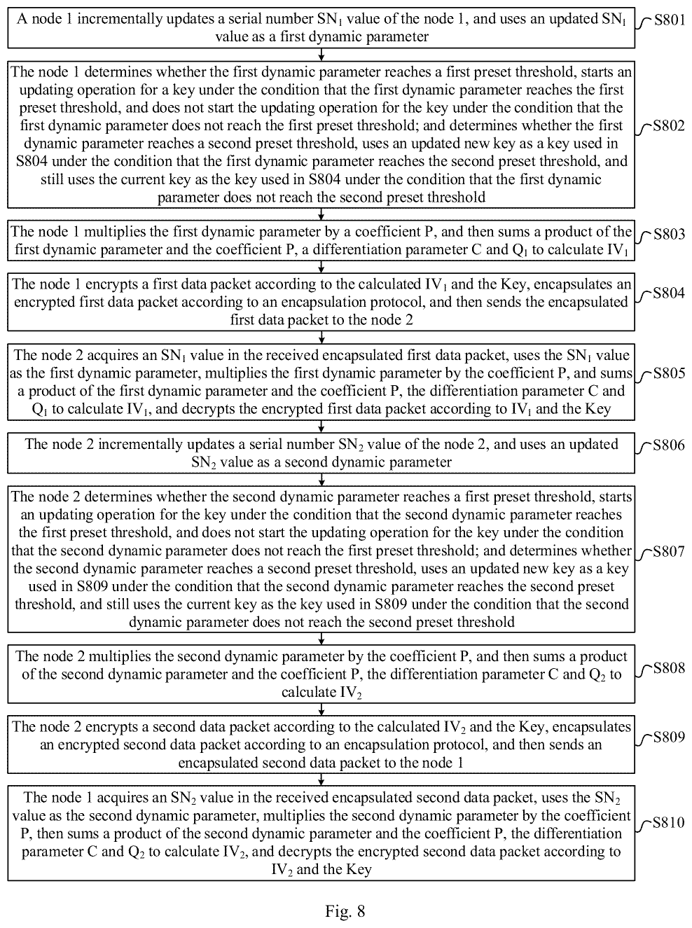

As shown in FIG. 7, a schematic diagram of data secure transmission having no encapsulation format is provided in an embodiment of the present application. It is assumed that communication traffic from a node 1 to a node 2 is DATA₁ₜₒ₂, communication traffic from the node 2 to the node 1 is DATA₂ₜₒ₁, and a key jointly used by the node 1 and the node 2 is Key.

Data traffic interaction between the node 1 and the node 2 executes the following steps.

S1, both communicating parties configure lengths of serial numbers SN₁ and SN₂, and initialize an SN₁ value and an SN₂ value.

S2, the node 1 calculates an IV value according to the length of SN₁ and the SN₁ value, and the node 2 calculates an IV₂ value according to the length of SN₂ and the SN₂ value.

A calculation process herein is the same as that in the embodiment of FIG. 6, which will not be repeated.

S3, traffic on both communication parties is encrypted and decrypted by using the IV₁/IV₂ value calculated and an encryption algorithm.

It should be noted that the node 1 and the node 2 communicate by means of data secure transmission having no encapsulation format. Before the node 1 sends DATA₁ₜₒ₂ to the node 2, the node 1 encrypts DATA₁ₜₒ₂ by using the Key and the calculated IV₁ value in combination with the encryption algorithm, does not need to encapsulate encrypted traffic according to an encapsulation protocol, and directly sends encrypted traffic to the node 2. After receiving the encrypted traffic sent by the node 1, the node 2 obtains the SN₂ value from the encrypted traffic, and decrypts the encrypted traffic according to the IV₁ value calculated by the node 2 and the Key in combination with the encryption algorithm to obtain DATA₁ₜₒ₂.

Similarly, before the node 2 sends DATA₂ₜₒ₁ to the node 1, the node 2 encrypts DATA₂ₜₒ₁ by using the Key and the calculated IV₂ value in combination with the encryption algorithm, does not need to encapsulate encrypted traffic according to an encapsulation protocol, and directly sends encrypted traffic to the node 1. After receiving the encrypted traffic sent by the node 2, the node 1 obtains the SN₂ value from the encrypted traffic, and decrypts the encrypted traffic according to the IV₂ value calculated by the node 1 and the Key in combination with the encryption algorithm to obtain DATA₂ₜₒ₁.

The embodiments of the present application will be described below by taking data secure transmission having an encapsulation format as an example. The data secure transmission having an encapsulation format and data secure transmission having no encapsulation format are basically the same except that the data secure transmission having no encapsulation format does not need encapsulation, which will not be repeated hereinafter.

As shown in FIG. 8, a flow chart for data secure transmission having an encapsulation format is provided in an embodiment of the present application. SN₁ overflowing before IV₁ and SN₂ overflowing before IV₂ will be described as an example. It should be noted that in the embodiment, before data secure transmission is performed between the node 1 and the node 2, lengths of SN₁ and SN₂ have been determined to be m between the node 1 and the node 2, and an SN₁ value and an SN₂ value are initialized. According to an encryption algorithm used, the lengths of IV₁ and IV₂ are determined to be n. As an optional implementation, the encryption algorithm used above is a symmetric encryption algorithm.

Flows of the data secure transmission having an encapsulation format according to the embodiment of FIG. 8 include the following.

S801, a node 1 incrementally updates a serial number SN₁ value of the node 1, and uses an updated SN₁ value as a first dynamic parameter.

S802, the node 1 determines whether the first dynamic parameter reaches a first preset threshold, starts an updating operation for a key under the condition that the first dynamic parameter reaches the first preset threshold, and does not start the updating operation for the key under the condition that the first dynamic parameter does not reach the first preset threshold; and determines whether the first dynamic parameter reaches a second preset threshold, uses an updated new key as a key used in S804 under the condition that the first dynamic parameter reaches the second preset threshold, and still uses the current key as the key used in S804 under the condition that the first dynamic parameter does not reach the second preset threshold.

For example, the first preset threshold may be 0.9×2^{m}, whether the SN₁ value reaches 90% of 2^{m} is determined, and if so, the updating operation for the key is started. Optionally, when the updating operation for the key is started, an updating operation for the differentiation parameter C may further be started. For example, the second preset threshold may be 2^{m}−1, and whether the SN₁ value reaches 2^{m}−1 is determined. The first preset threshold is less than the second preset threshold, and the second preset threshold is not greater than a maximum value of SN₁. Optionally, IV₁ may further be calculated in S803 by using a new differentiation parameter C when the updated new key is used as the key used in S804.

S803, the node 1 multiplies the first dynamic parameter by a coefficient P, and then sums a product of the first dynamic parameter and the coefficient P, a differentiation parameter C and Q₁ to calculate IV₁.

For example, if an increment value is 1, the node 1 adds 1 to the current SN₁ value, takes P=2 and Q₁=0, and calculates IV₁ by using IV₁=C+SN₁×2.

S804, the node 1 encrypts a first data packet according to the calculated IV₁ and the Key, encapsulates an encrypted first data packet according to an encapsulation protocol, and then sends the encapsulated first data packet to the node 2.

The node 1 encrypts, by using IV₁ and the Key as two input parameters of an encryption algorithm, DATA₁ₜₒ₂ by using the symmetric encryption algorithm, i.e., (DATA₁ₜₒ₂)_{ciphertext}=FUN_{encrypt}(IV₁, Key, DATA₁ₜₒ₂), then encapsulates (DATA₁ₜₒ₂)_{ciphertext} according to the encapsulation protocol, and sends encapsulated (DATA₁ₜₒ₂)_{ciphertext} to the node 2 after completion.

It should be noted that after sending the encrypted first data packet to the node 2, the node 1 may execute relevant steps anew from S801 to calculate new IV₁, and encrypts a data packet subsequently sent to the node 2 according to the calculated IV₁ and the key. After the node 1 sends a plurality of encrypted data packets to the node 2, if the SN₁ value of the node 1 overflows, the node 1 initializes the SN₁ value, and then executes relevant steps from S801.

S805, the node 2 acquires an SN₁ value in the received encapsulated first data packet, uses the SN₁ value as the first dynamic parameter, multiplies the first dynamic parameter by the coefficient P, and sums a product of the first dynamic parameter and the coefficient P, the differentiation parameter C and Q₁ to calculate IV₁, and decrypts the encrypted first data packet according to the calculated IV₁ and the Key.

When receiving communication traffic of the node 1, the node 2 acquires the SN₁ value in an encapsulated message, calculates IV₁ by using IV₁=C+SN₁×2, and decrypts, by using IV₁ and the Key as two input parameters of the encryption algorithm, (DATA₁ₜₒ₂)_{ciphertext} by using the symmetric encryption algorithm, i.e., (DATA₁ₜₒ₂)ₚₗₐᵢₙₜₑₓₜ=FUN_{decipher}(IV₁, Key, (DATA₁ₜₒ₂)_{ciphertext} ).

S806, the node 2 incrementally updates a serial number SN₂ value of the node 2, and uses an updated SN₂ value as a second dynamic parameter.

S807, the node 2 determines whether the second dynamic parameter reaches a first preset threshold, starts an updating operation for the key under the condition that the second dynamic parameter reaches the first preset threshold, and does not start the updating operation for the key under the condition that the second dynamic parameter does not reach the first preset threshold; and determines whether the second dynamic parameter reaches a second preset threshold, uses an updated new key as a key used in S809 under the condition that the second dynamic parameter reaches the second preset threshold, and still uses the current key as the key used in S809 under the condition that the second dynamic parameter does not reach the second preset threshold.

For example, the first preset threshold may be 0.9×2^{m}, and whether the SN₂ value reaches 90% of 2^{m} is determined, and if so, the updating operation for the key is started. Optionally, when the updating operation for the key is started, an updating operation for the differentiation parameter C may further be started. For example, the second preset threshold may be 2^{m}−1, and whether the SN₂ value reaches 2^{m}−1 is determined. The first preset threshold is less than the second preset threshold, and the second preset threshold is not greater than a maximum value of SN₂. Optionally, IV₂ may further be calculated in S808 according to a new differentiation parameter C when the updated new key is used as the key used in S809.

S808, the node 2 multiplies the second dynamic parameter by the coefficient P, and then sums a product of the second dynamic parameter and the coefficient P, the differentiation parameter C and Q₂ to calculate IV₂.

For example, if an increment value is 1, the node 2 adds 1 to the SN₂ value, takes P=2 and Q₂=−1, and calculates IV₂ according to IV₂=C+SN₂×2−1.

S809, the node 2 encrypts a second data packet according to the calculated IV₂ and the Key, encapsulates an encrypted second data packet according to an encapsulation protocol, and then sends an encapsulated second data packet to the node 1.

The node 2 encrypts, by using IV₂ and the Key as two input parameters of an encryption algorithm, DATA₂ₜₒ₁ by using the symmetric encryption algorithm, i.e., (DATA₂ₜₒ₁)_{ciphertext}=FUN_{encrypt}(IV₂, Key, DATA₂ₜₒ₁), then encapsulates (DATA₂ₜₒ₁)_{ciphertext} according to the encapsulation protocol, and sends encapsulated (DATA₂ₜₒ₁)_{ciphertext} to the node 1 after completion.

It should be noted that after sending the encrypted second data packet to the node 1, the node 2 may execute relevant steps anew from S806 to calculate a new IV₂, and encrypts a data packet subsequently sent to the node 1 by using the calculated IV₂ and the key. After the node 2 sends a plurality of encrypted data packets to the node 1, if the SN₂ value of the node 2 overflows, the node 2 initializes the SN₂ value, and then executes relevant steps from S806.

S810, the node 1 acquires an SN₂ value in the received encapsulated second data packet, uses the SN₂ value as the second dynamic parameter, multiplies the second dynamic parameter by the coefficient P, and sums a product of the second dynamic parameter and the coefficient P, the differentiation parameter C and Q₂ to calculate IV₂, and decrypts the encrypted second data packet according to IV₂ and the Key.

When receiving communication traffic of the node 2, the node 1 acquires the SN₂ value in an encapsulated message, calculates IV₂ by using IV₂=C+SN₂×2−1, and decrypts, by using IV₂ and the Key as two input parameters of the encryption algorithm, (DATA₂ₜₒ₁)_{ciphertext} by using the symmetric encryption algorithm, i.e., (DATA₂ₜₒ₁)ₚₗₐᵢₙₜₑₓₜ=FUN_{decipher}(IV₂, Key, (DATA₂ₜₒ₁)_{ciphertext}).

TABLE 1
Comparison of SN value changes between the solution of the embodiment
of the present application and the solution of the prior art

| Solution of embodiment of the present application | | | | Solution of the prior art | | | |
|---|---|---|---|---|---|---|---|
| Node 1 | | Node 2 | | Node 1 | | Node 2 | |
| SN₁ | IV₁ = C + SN₁ × 2 | SN₂ | IV₂ = C + SN₂ × 2 − 1 | SN₁ | IV₁ = SN₁ | SN₂ | IV₂ = SN₂ |
| 1 | 2 + C | 1 | 1 + C | 1 | 1 | 2 | 2 |
| 2 | 4 + C | 2 | 3 + C | 3 | 3 | 4 | 4 |
| 3 | 6 + C | 3 | 5 + C | 5 | 5 | 6 | 6 |
| 4 | 8 + C | 4 | 7 + C | 7 | 7 | 8 | 8 |
| 5 | 10 + C | 5 | 9 + C | 9 | 9 | 10 | 10 |
| 6 | 12 + C | 6 | 11 + C | 11 | 11 | 12 | 12 |
| 7 | 14 + C | 7 | 13 + C | 13 | 13 | 14 | 14 |
| 8 | 16 + C | 8 | 15 + C | 15 | 15 | 16 | 16 |
| 9 | 18 + C | 9 | 17 + C | 17 | 17 | 18 | 18 |
| | | | | (overflow) | | (overflow) | |
| 10 | 20 + C | 10 | 19 + C | | | | |
| 11 | 22 + C | 11 | 21 + C | | | | |
| 12 | 24 + C | 12 | 23 + C | | | | |
| 13 | 26 + C | 13 | 25 + C | | | | |
| 14 | 28 + C | 14 | 27 + C | | | | |
| 15 | 30 + C | 15 | 29 + C | | | | |
| 16 | 32 + C | 16 | 31 + C | | | | |

In Table 1 above, comparison of SN value changes between the solution of the present application and the solution of the prior art is deduced. In Table 1, the length of SN₁ and SN₂ is set to 4 bits. That is, a maximum value of SN₁ and SN₂ is 16. Initial values of SN₁ and SN₂ in the solution of the embodiment of the present application start from 1. Assuming P=2, Q₁=0 and Q₂=−1, values of P, Q₁ and Q₂ are substituted into the solution of the node 1 and the node 2, it may be found that the SN₁ value and the SN₂ value only need to be processed by adding 1 in each subsequent round of processing. According to a mode of IV calculation according to the embodiment of the present application, IV₁ calculated by the node 1 according to the SN₁ value and IV₂ calculated by the node 2 according to the SN₂ value are different.

However, in the solution of the prior art, in order to ensure that two nodes use different IV values, a method in the solution of the prior art requires that one of the SN₁ value and the SN₂ value is odd (for example, the initial value of SN₁ is 1), and the other one is even (for example, the initial value of SN₂ is 2). The SN₁ value and the SN₂ value need to be processed by adding 2 in each subsequent round of processing. Thus, it is ensured that IV₁ calculated by the node 1 and IV₂ calculated by the node 2 are different.

Since the solution of the present application uses a specific mode of IV calculation, the corresponding SN values of the node 1 and the node 2 may be the same, and only 1 needs to be added to the corresponding SN values in each round of processing. Thus, a use space of SN₁ and SN₂ in the solution of the present application is twice larger than that of SN₁ and SN₂ in the prior art, overflow becomes slower, and a corresponding key updating frequency is reduced by one time. Thus, system performance can be effectively improved.

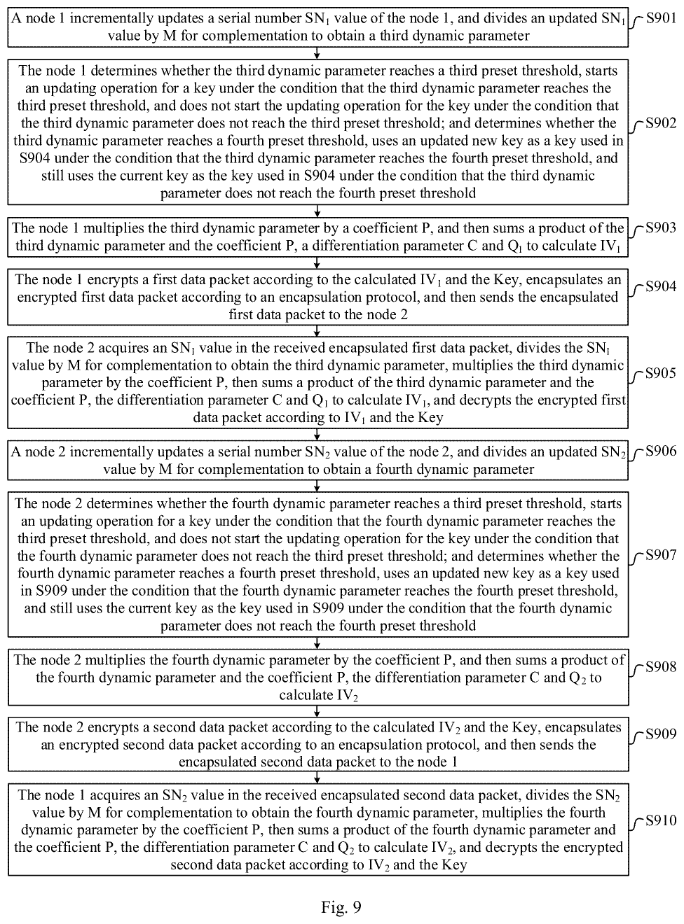

As shown in FIG. 9, a flow chart of another data secure transmission having an encapsulation format is provided in an embodiment of the present application. SN₁ overflowing before IV₁ and SN₂ overflowing before IV₂ will be described as an example. It should be noted that in the embodiment, before data secure transmission is performed between the node 1 and the node 2, lengths of SN₁ and SN₂ have been determined to be m between the node 1 and the node 2, and an SN₁ value and an SN₂ value are initialized. According to an encryption algorithm used, the lengths of IV₁ and IV₂ are determined to be n. As an optional implementation, the encryption algorithm used above is a symmetric encryption algorithm.

Flows of the data secure transmission having an encapsulation format according to the embodiment of FIG. 9 include the following.

S901, a node 1 incrementally updates a serial number SN₁ value of the node 1, and divides an updated SN₁ value by M for complementation to obtain a third dynamic parameter.

S902, the node 1 determines whether the third dynamic parameter reaches a third preset threshold, starts an updating operation for a key under the condition that the third dynamic parameter reaches the third preset threshold, and does not start the updating operation for the key under the condition that the third dynamic parameter does not reach the third preset threshold; and determines whether the third dynamic parameter reaches a fourth preset threshold, uses an updated new key as a key used in S904 under the condition that the third dynamic parameter reaches the fourth preset threshold, and still uses the current key as the key used in S904 under the condition that the third dynamic parameter does not reach the fourth preset threshold.

For example, the third preset threshold may be 0.9×2^{n-k}, whether SN₁ %2^{n-k} reaches 90% of 2^{n-k} is determined, and if so, the updating operation for the key is started. Optionally, when the updating operation for the key is started, an updating operation for the differentiation parameter C may further be started. For example, the fourth preset threshold may be 2^{n-k}−1, and whether SN₁ %2^{n-k} reaches 2^{n-k}−1 is determined. The third preset threshold is less than the fourth preset threshold, and the fourth preset threshold is not greater than a maximum value of the lower-order n−k bits of IV₁. Optionally, IV₁ may further be calculated in S903 by using a new differentiation parameter C when the updated new key is used as the key used in S904.

S903, the node 1 multiplies the third dynamic parameter by a coefficient P, and then sums a product of the third dynamic parameter and the coefficient P, a differentiation parameter C and Q₁ to calculate IV₁.

M represents a maximum value 2^{n-k} of n−k lower-order bits of IV₁ when IV₁ overflows firstly. For example, if an increment value is 1, the node 1 adds 1 to the current SN₁ value, takes P=2 and Q₁=0, and calculates IV₁ by using IV₁=C+SN₁ %2^{n-k}×2.

S904, the node 1 encrypts a first data packet according to the calculated IV₁ and the Key, encapsulates an encrypted first data packet according to an encapsulation protocol, and then sends the encapsulated first data packet to the node 2.

The node 1 encrypts, by using IV₁ and the Key as two input parameters of an encryption algorithm, DATA₁ₜₒ₂ by using the symmetric encryption algorithm, i.e., (DATA₁ₜₒ₂)_{ciphertext}=FUN_{encrypt}(IV₁, Key, DATA₁ₜₒ₂), then encapsulates (DATA₁ₜₒ₂)_{ciphertext} according to the encapsulation protocol, and sends encapsulated (DATA₁ₜₒ₂)_{ciphertext} to the node 2 after completion.

It should be noted that after sending the encrypted first data packet to the node 2, the node 1 may execute relevant steps anew from S901 to calculate new IV₁, and encrypts a data packet subsequently sent to the node 2 according to the calculated IV₁ and the key. After the node 1 sends a plurality of encrypted data packets to the node 2, if the SN₁ value of the node 1 overflows, the node 1 initializes the SN₁ value, and then executes relevant steps from S901.

S905, the node 2 acquires an SN₁ value in the received encapsulated first data packet, divides the SN₁ value by M for complementation to obtain the third dynamic parameter, multiplies the third dynamic parameter by the coefficient P, and sums a product of the third dynamic parameter and the coefficient P, the differentiation parameter C and Q₁ to calculate IV₁, and decrypts the encrypted first data packet according to IV₁ and the Key.

When receiving communication traffic of the node 1, the node 2 acquires an SN₁ value in an encapsulated message, calculates IV₁ by using IV₁=C+SN₁ %2^{n-k}×2, and decrypts, by using IV₁ and the Key as two input parameters of the encryption algorithm, (DATA₁ₜₒ₂)_{ciphertext} by using the symmetric encryption algorithm, i.e., (DATA₁ₜₒ₂)ₚₗₐᵢₙₜₑₓₜ=FUN_{decipher}(IV₁, Key, (DATA₁ₜₒ₂)_{ciphertext}).

S906, a node 2 incrementally updates a serial number SN₂ value of the node 2, and divides an updated SN₂ value by M for complementation to obtain a fourth dynamic parameter.

S907, the node 2 determines whether the fourth dynamic parameter reaches a third preset threshold, starts an updating operation for a key under the condition that the fourth dynamic parameter reaches the third preset threshold, and does not start the updating operation for the key under the condition that the fourth dynamic parameter does not reach the third preset threshold; and determines whether the fourth dynamic parameter reaches a fourth preset threshold, uses an updated new key as a key used in S909 under the condition that the fourth dynamic parameter reaches the fourth preset threshold, and still uses the current key as the key used in S909 under the condition that the fourth dynamic parameter does not reach the fourth preset threshold.

For example, the third preset threshold may be 0.9×2^{n-k}, whether SN₂ %2^{n-k} reaches 90% of 2^{n-k} is determined, and if so, the updating operation for the key is started. Optionally, when the updating operation for the key is started, an updating operation for the differentiation parameter C may further be started. For example, the fourth preset threshold may be 2^{n-k}−1,and whether SN₂ %2^{n-k} reaches 2^{n-k}−1 is determined. The third preset threshold is less than the fourth preset threshold, and the fourth preset threshold is not greater than a maximum value of lower-order n−k bits of IV₂. Optionally, IV₂ may further be calculated in S908 according to a new differentiation parameter C when the updated new key is used as the key used in S909.

S908, the node 2 multiplies the fourth dynamic parameter by the coefficient P, and then sums a product of the fourth dynamic parameter and the coefficient P, the differentiation parameter C and Q₂ to calculate IV₂.

M represents a maximum value 2^{n-k} of n−k lower-order bits of IV₂ when IV₂ overflows firstly. For example, if an increment value is 1, the node 2 adds 1 to the SN₂ value, takes P=2 and Q₂=−1, and calculates IV₂ according to IV₂=C+SN₂ %2^{n-k}×2−1.

S909, the node 2 encrypts a second data packet according to the calculated IV₂ and the Key, encapsulates an encrypted second data packet according to an encapsulation protocol, and then sends the encapsulated second data packet to the node 1.

The node 2 encrypts, by using IV₂ and the Key as two input parameters of an encryption algorithm, DATA₂ₜₒ₁ by using the symmetric encryption algorithm, i.e., (DATA₂ₜₒ₁)_{ciphertext}=FUN_{encrypt}(IV₂, Key, DATA₂ₜₒ₁), then encapsulates (DATA₂ₜₒ₁)_{ciphertext} according to the encapsulation protocol, and sends encapsulated (DATA₂ₜₒ₁)_{ciphertext} to the node 1 after completion.

It should be noted that after sending the encrypted second data packet to the node 1, the node 2 may execute relevant steps anew from S906 to calculate a new IV₂, and encrypts a data packet subsequently sent to the node 1 by using the calculated IV₂ and the key. After the node 2 sends a plurality of encrypted data packets to the node 1, if the SN₂ value of the node 2 overflows, the node 2 initializes the SN₂ value, and then executes relevant steps from S906.

S910, the node 1 acquires an SN₂ value in the received encapsulated second data packet, divides the SN₂ value by M for complementation to obtain the fourth dynamic parameter, multiplies the fourth dynamic parameter by the coefficient P, and sums a product of the fourth dynamic parameter and the coefficient P, the differentiation parameter C and Q₂ to calculate IV₂, and decrypts the encrypted second data packet according to IV₂ and the Key.

When receiving communication traffic of the node 2, the node 1 acquires the SN₂ value in an encapsulated message, calculates IV₂ by using IV₂=C+SN₂ %2^{n-k}×2−1, and decrypts, by using IV₂ and the Key as two input parameters of the encryption algorithm, (DATA₂ₜₒ₁)_{ciphertext} by using the symmetric encryption algorithm, i.e., (DATA₂ₜₒ₁)ₚₗₐᵢₙₜₑₓₜ=FUN_{decipher}(IV₂, Key, (DATA₂ₜₒ₁)_{ciphertext}).

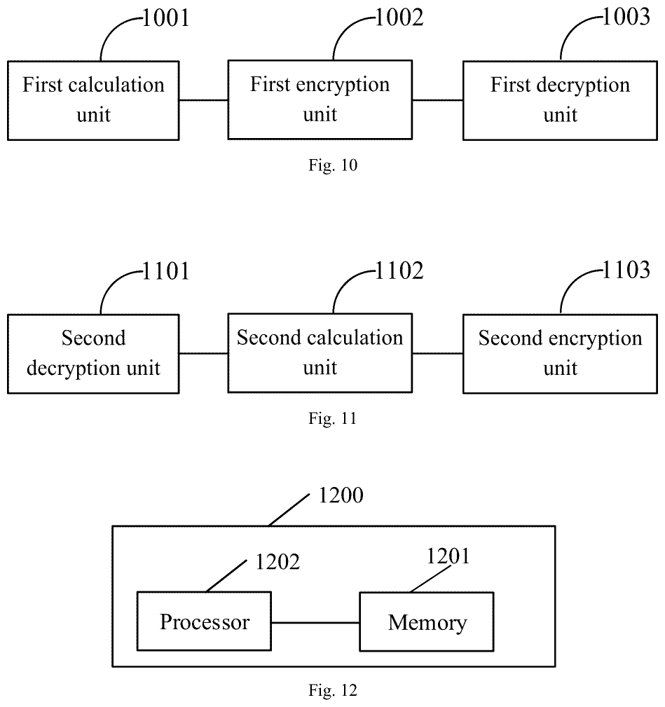

As shown in FIG. 10, a schematic diagram of an apparatus for data secure transmission is provided in an embodiment of the present application. The apparatus includes: a first calculation unit 1001, configured to incrementally update a serial number SN₁ value initialized by the apparatus, and perform first mathematical transformation on an updated SN₁ value to calculate a first initialization vector IV₁; a first encryption unit 1002, configured to encrypt a first data packet according to the calculated IV₁ and a key, and then send an encrypted first data packet to a node 2; and a first decryption unit 1003, configured to acquire an SN₂ value in a received second data packet, perform second mathematical transformation on the acquired SN₂ value to calculate a second initialization vector IV₂, and decrypt an encrypted second data packet according to the calculated IV₂ and the key, where the first mathematical transformation and the second mathematical transformation cause the calculated IV₁ to be unequal to the calculated IV₂.

Optionally, before calculating the first initialization vector IV₁, the first calculation unit 1001 is further configured to: determine an overflow sequence of SN₁ and IV₁; perform the first mathematical transformation on the updated SN₁ value to calculate IV₁ when it is determined that SN₁ overflows firstly as follows: setting the SN₁ value configured to calculate IV₁ as a first dynamic parameter, multiply the first dynamic parameter by a coefficient P, and then summing a product of the first dynamic parameter and the coefficient P, a differentiation parameter C and a first parameter Q₁ to calculate IV₁; and perform the first mathematical transformation on the updated SN₁ value to calculate IV₁ when it is determined that IV₁ overflows firstly as follows: dividing the SN₁ value configured to calculate IV₁ by M for complementation to obtain a third dynamic parameter, multiply the third dynamic parameter by the coefficient P, and then summing a product of the third dynamic parameter and the coefficient P, the differentiation parameter C and Q₁ to calculate IV₁, where P is unequal to 1 and 0, and Q₁ is 0 or is not an integer multiple of P; and a length of C is equal to a length n of IV₁, C includes higher-order bits of k bits and lower-order bits of n−k bits, a value of the lower-order bits is zero, and M is a maximum value 2^{n-k} of lower-order n−k bits of IV₁ when IV₁ overflows firstly.

Optionally, the first calculation unit 1001 determines the overflow sequence of SN₁ and IV₁ as follows: calculating a difference between the length n of IV₁ and a length k of the higher-order bits; determining SN₁ to overflow firstly under the condition that a length m of SN₁ is not greater than the difference; and determining IV₁ to overflow firstly under the condition that the length m of SN₁ is greater than the difference.

Optionally, before calculating the second initialization vector IV₂, the first decryption unit 1003 is further configured to: determine an overflow sequence of SN₂ and IV₂; perform the second mathematical transformation on the acquired SN₂ value to calculate IV₂ when it is determined that SN₂ overflows firstly as follows: setting the SN₂ value configured to calculate IV₂ as a second dynamic parameter, multiply the second dynamic parameter by the coefficient P, and then summing a product of the second dynamic parameter and the coefficient P, the differentiation parameter C and a second parameter Q₂ to calculate IV₂; and perform the second mathematical transformation on the acquired SN₂ value to calculate IV₂ when it is determined that IV₂ overflows firstly as follows: dividing the SN₂ value configured to calculate IV₂ by M for complementation to obtain a fourth dynamic parameter, multiply the fourth dynamic parameter by the coefficient P, and then summing a product of the fourth dynamic parameter and the coefficient P, the differentiation parameter C and Q₂ to calculate IV₂, where Q₂ is 0 or is not an integer multiple of P, and is different from Q₁; and a length of C is equal to a length n of IV₂, and M is a maximum value 2^{n-k} of lower-order n−k bits of IV₂ when IV₂ overflows firstly.

Optionally, the first decryption unit 1003 determines the overflow sequence of SN₂ and IV₂ as follows: calculating a difference between the length n of IV₂ and a length k of the higher-order bits; determining SN₂ to overflow firstly under the condition that a length m of SN₂ is not greater than the difference; and determining IV₂ to overflow firstly under the condition that the length m of SN₂ is greater than the difference.

Optionally, before calculating the first initialization vector IV₁, the first calculation unit 1001 is further configured to: start an updating operation for the key when it is determined that SN₁ overflows firstly and the first dynamic parameter reaches a first preset threshold, and use an updated new key as a key used during data sending when the first dynamic parameter reaches a second preset threshold, where the first preset threshold is less than the second preset threshold, and the second preset threshold is not greater than a maximum value of SN₁; and start an updating operation for the key when it is determined that IV₁ overflows firstly and the third dynamic parameter reaches a third preset threshold, and use an updated new key as a key used during data sending when the third dynamic parameter reaches a fourth preset threshold, where the third preset threshold is less than the fourth preset threshold, and the fourth preset threshold is not greater than a maximum value of lower-order n−k bits of IV₁.

Optionally, before calculating the second initialization vector IV₂, the first decryption unit 1003 is further configured to: start an updating operation for the key when it is determined that SN₂ overflows firstly and the second dynamic parameter reaches a first preset threshold, and use an updated new key as a key used during data sending when the second dynamic parameter reaches a second preset threshold, where the first preset threshold is less than the second preset threshold, and the second preset threshold is not greater than a maximum value of SN₂; and start an updating operation for the key when it is determined that IV₂ overflows firstly and the fourth dynamic parameter reaches a third preset threshold, and use an updated new key as a key used during data sending when the fourth dynamic parameter reaches a fourth preset threshold, where the third preset threshold is less than the fourth preset threshold, and the fourth preset threshold is not greater than a maximum value of lower-order n−k bits of IV₂.

Optionally, when starting the updating operation for the key, the first calculation unit 1001/first decryption unit 1003 is further configured to: start a calculation operation of a new value of a number k of bits of the higher-order bits to generate a new differentiation parameter C; or, start a calculation operation of a new value N of the higher-order bits of the k bits to generate a new differentiation parameter C.

Optionally, when using the updated new key as a key used during data sending, the first calculation unit 1001/first decryption unit 1003 is further configured to: calculate an initialization vector (IV) used during data sending according to the new differentiation parameter C.

Optionally, P is set as 2, Q₁ is set as 0, Q₂ is set as −1, and C is set as a random number.

As shown in FIG. 11, a schematic diagram of another apparatus for data secure transmission is provided in an embodiment of the present application. The apparatus includes: a second decryption unit 1101, configured to acquire an SN₁ value in a received first data packet, perform first mathematical transformation on the acquired SN₁ value to calculate a first initialization vector IV₁, and decrypt an encrypted first data packet according to the calculated IV₁ and a key; a second calculation unit 1102, configured to incrementally update a serial number SN₂ value initialized by the apparatus, and perform second mathematical transformation on an updated SN₂ value to calculate a second initialization vector IV₂; and a second encryption unit 1103, configured to encrypt a second data packet according to the calculated IV₂ and the key, and then send an encrypted second data packet to a node 1, where the first mathematical transformation and the second mathematical transformation cause the calculated IV₁ to be unequal to the calculated IV₂.

Optionally, before calculating the first initialization vector IV₁, the second decryption unit 1101 is further configured to: determine an overflow sequence of SN₁ and IV₁; perform the first mathematical transformation on the acquired SN₁ value to calculate IV₁ when it is determined that SN₁ overflows firstly as follows: setting the SN₁ value configured to calculate IV₁ as a first dynamic parameter, multiply the first dynamic parameter by a coefficient P, and then summing a product of the first dynamic parameter and the coefficient P, a differentiation parameter C and a first parameter Q₁ to calculate IV₁; and perform the first mathematical transformation on the acquired SN₁ value to calculate IV₁ when it is determined that IV₁ overflows firstly as follows: dividing the SN₁ value configured to calculate IV₁ by M for complementation to obtain a third dynamic parameter, multiply the third dynamic parameter by the coefficient P, and then summing a product of the third dynamic parameter and the coefficient P, the differentiation parameter C and Q₁ to calculate IV₁, where P is unequal to 1 and 0, and Q₁ is 0 or is not an integer multiple of P; and a length of C is equal to a length n of IV₁, C includes higher-order bits of k bits and lower-order bits of n−k bits, a value of the lower-order bits is zero, and M is a maximum value 2^{n-k} of lower-order n−k bits of IV₁ when IV₁ overflows firstly.

Optionally, the second decryption unit 1101 determines the overflow sequence of SN₁ and IV₁ as follows: calculating a difference between the length n of IV₁ and a length k of the higher-order bits; determining SN₁ to overflow firstly under the condition that a length m of SN₁ is not greater than the difference; and determining IV₁ to overflow firstly under the condition that the length m of SN₁ is greater than the difference.

Optionally, before calculating the second initialization vector IV₂, the second calculation unit 1102 is further configured to: determine an overflow sequence of SN₂ and IV₂; perform the second mathematical transformation on the updated SN₂ value to calculate SN₂ when it is determined that SN₂ overflows firstly as follows: setting the SN₂ value configured to calculate IV₂ as a second dynamic parameter, multiply the second dynamic parameter by the coefficient P, and then summing a product of the second dynamic parameter and the coefficient P, the differentiation parameter C and a second parameter Q₂ to calculate IV₂; and perform the second mathematical transformation on the updated SN₂ value to calculate IV₂ when it is determined that IV₂ overflows firstly as follows: dividing the SN₂ value configured to calculate IV₂ by M for complementation to obtain a fourth dynamic parameter, multiply the fourth dynamic parameter by the coefficient P, and then summing a product of the fourth dynamic parameter and the coefficient P, the differentiation parameter C and Q₂ to calculate IV₂, where Q₂ is 0 or is not an integer multiple of P, and is different from Q₁; and a length of C is equal to a length n of IV₂, and M is a maximum value 2^{n-k} of lower-order n−k bits of IV₂ when IV₂ overflows firstly.

Optionally, the second calculation unit 1102 determines the overflow sequence of SN₂ and IV₂ as follows: calculating a difference between the length n of IV₂ and a length k of the higher-order bits; determining SN₂ to overflow firstly under the condition that a length m of SN₂ is not greater than the difference; and determining IV₂ to overflow firstly under the condition that the length m of SN₂ is greater than the difference.

Optionally, before calculating the first initialization vector IV₁, the second decryption unit 1101 is further configured to: start an updating operation for the key when it is determined that SN₁ overflows firstly and the first dynamic parameter reaches a first preset threshold, and use an updated new key as a key used during data sending when the first dynamic parameter reaches a second preset threshold, where the first preset threshold is less than the second preset threshold, and the second preset threshold is not greater than a maximum value of SN₁; and start an updating operation for the key when it is determined that IV₁ overflows firstly and the third dynamic parameter reaches a third preset threshold, and use an updated new key as a key used during data sending when the third dynamic parameter reaches a fourth preset threshold, where the third preset threshold is less than the fourth preset threshold, and the fourth preset threshold is not greater than a maximum value of lower-order n−k bits of IV₁.

Optionally, before calculating the second initialization vector IV₂, the second calculation unit 1102 is further configured to: start an updating operation for the key when it is determined that SN₂ overflows firstly and the second dynamic parameter reaches a first preset threshold, and use an updated new key as a key used during data sending when the second dynamic parameter reaches a second preset threshold, where the first preset threshold is less than the second preset threshold, and the second preset threshold is not greater than a maximum value of SN₂; and start an updating operation for the key when it is determined that IV₂ overflows firstly and the fourth dynamic parameter reaches a third preset threshold, and use an updated new key as a key used during data sending when the fourth dynamic parameter reaches a fourth preset threshold, where the third preset threshold is less than the fourth preset threshold, and the fourth preset threshold is not greater than a maximum value of lower-order n−k bits of IV₂.

Optionally, when starting the updating operation for the key, the second decryption unit 1101/second calculation unit 1102 is further configured to: start a calculation operation of a new value of a number k of bits of the higher-order bits to generate a new differentiation parameter C; or, start a calculation operation of a new value N of the higher-order bits of the k bits to generate a new differentiation parameter C.

Optionally, when using the updated new key as a key used during data sending, the second decryption unit 1101/second calculation unit 1102 is further configured to: calculate an initialization vector (IV) used during data sending according to the new differentiation parameter C.

Optionally, P is set as 2, Q₁ is set as 0, Q₂ is set as −1, and C is set as a random number.

As shown in FIG. 12, a schematic diagram of a device 1200 for data secure transmission is provided in an embodiment of the present application. The device includes a memory 1201 and a processor 1202, where the memory 1201 is configured to store a computer program; and the processor 1202 is configured to read a program in the memory 1201 and execute steps of the method for data secure transmission at a side of a node 1 or node 2 in the above embodiment.

When the processor reads the program in the memory and executes steps of the method for data secure transmission at a side of a node 1 in the above embodiment, the processor is specifically configured to: incrementally update a serial number SN₁ value initialized by the node 1, and perform first mathematical transformation on an updated SN₁ value to calculate a first initialization vector IV₁; encrypt a first data packet according to the calculated IV₁ and a key, and then send an encrypted first data packet to a node 2; acquire an SN₂ value in a received second data packet, perform second mathematical transformation on the acquired SN₂ value to calculate a second initialization vector IV₂, and decrypt an encrypted second data packet according to the calculated IV₂ and the key, where the first mathematical transformation and the second mathematical transformation cause the calculated IV₁ to be unequal to the calculated IV₂.

Optionally, before calculating the first initialization vector IV₁, the processor is further configured to: determine an overflow sequence of SN₁ and IV₁; perform the first mathematical transformation on the updated SN₁ value to calculate IV₁ when it is determined that SN₁ overflows firstly as follows: setting the SN₁ value configured to calculate IV₁ as a first dynamic parameter, multiply the first dynamic parameter by a coefficient P, and then summing a product of the first dynamic parameter and the coefficient P, a differentiation parameter C and a first parameter Q₁ to calculate IV₁; and perform the first mathematical transformation on the updated SN₁ value to calculate IV₁ when it is determined that IV₁ overflows firstly as follows: dividing the SN₁ value configured to calculate IV₁ by M for complementation to obtain a third dynamic parameter, multiply the third dynamic parameter by the coefficient P, and then summing a product of the third dynamic parameter and the coefficient P, the differentiation parameter C and Q₁ to calculate IV₁, where P is unequal to 1 and 0, and Q₁ is 0 or is not an integer multiple of P; and a length of C is equal to a length n of IV₁, C includes higher-order bits of k bits and lower-order bits of n−k bits, a value of the lower-order bits is zero, and M is a maximum value 2^{n-k} of lower-order n−k bits of IV₁ when IV₁ overflows firstly.

Optionally, the processor determines the overflow sequence of SN₁ and IV₁ as follows: calculating a difference between the length n of IV₁ and a length k of the higher-order bits; determining SN₁ to overflow firstly under the condition that a length m of SN₁ is not greater than the difference; and determining IV₁ to overflow firstly under the condition that the length m of SN₁ is greater than the difference.

Optionally, before calculating the second initialization vector IV₂, the processor is further configured to: determine an overflow sequence of SN₂ and IV₂; perform the second mathematical transformation on the acquired SN₂ value to calculate IV₂ when it is determined that SN₂ overflows firstly as follows: setting the SN₂ value configured to calculate IV₂ as a second dynamic parameter, multiply the second dynamic parameter by the coefficient P, and then summing a product of the second dynamic parameter and the coefficient P, the differentiation parameter C and a second parameter Q₂ to calculate IV₂; and perform the second mathematical transformation on the acquired SN₂ value to calculate IV₂ when it is determined that IV₂ overflows firstly as follows: dividing the SN₂ value configured to calculate IV₂ by M for complementation to obtain a fourth dynamic parameter, multiply the fourth dynamic parameter by the coefficient P, and then summing a product of the fourth dynamic parameter and the coefficient P, the differentiation parameter C and Q₂ to calculate IV₂, where Q₂ is 0 or is not an integer multiple of P, and is different from Q₁; and a length of C is equal to a length n of IV₂, and M is a maximum value 2^{n-k} of lower-order n−k bits of IV₂ when IV₂ overflows firstly.

Optionally, the processor determines the overflow sequence of SN₂ and IV₂ as follows: calculating a difference between the length n of IV₂ and a length k of the higher-order bits; determining SN₂ to overflow firstly under the condition that a length m of SN₂ is not greater than the difference; and determining IV₂ to overflow firstly under the condition that the length m of SN₂ is greater than the difference.

Before calculating the first initialization vector IV₁, the processor is further configured to: start an updating operation for the key when it is determined that SN₁ overflows firstly and the first dynamic parameter reaches a first preset threshold, and use an updated new key as a key used during data sending when the first dynamic parameter reaches a second preset threshold, where the first preset threshold is less than the second preset threshold, and the second preset threshold is not greater than a maximum value of SN₁; and start an updating operation for the key when it is determined that IV₁ overflows firstly and the third dynamic parameter reaches a third preset threshold, and use an updated new key as a key used during data sending when the third dynamic parameter reaches a fourth preset threshold, where the third preset threshold is less than the fourth preset threshold, and the fourth preset threshold is not greater than a maximum value of lower-order n−k bits of IV₁.

Optionally, before calculating the second initialization vector IV₂, the processor is further configured to: start an updating operation for the key when it is determined that SN₂ overflows firstly and the second dynamic parameter reaches a first preset threshold, and use an updated new key as a key used during data sending when the second dynamic parameter reaches a second preset threshold, where the first preset threshold is less than the second preset threshold, and the second preset threshold is not greater than a maximum value of SN₂; and start an updating operation for the key when it is determined that IV₂ overflows firstly and the fourth dynamic parameter reaches a third preset threshold, and use an updated new key as a key used during data sending when the fourth dynamic parameter reaches a fourth preset threshold, where the third preset threshold is less than the fourth preset threshold, and the fourth preset threshold is not greater than a maximum value of lower-order n−k bits of IV₂.

Optionally, when starting the updating operation for the key, the processor is further configured to: start a calculation operation of a new value of a number k of bits of the higher-order bits to generate a new differentiation parameter C; or, start a calculation operation of a new value N of the higher-order bits of the k bits to generate a new differentiation parameter C.

Optionally, when using the updated new key as a key used during data sending, the processor is further configured to: calculate an initialization vector (IV) used during data sending according to the new differentiation parameter C.

Optionally, P is set as 2, Q₁ is set as 0, Q₂ is set as −1, and C is set as a random number.

When the processor reads the program in the memory and executes steps of the method for data secure transmission at a side of a node 2 in the above embodiment, the processor is specifically configured to: acquire an SN₁ value in a received first data packet, perform first mathematical transformation on the acquired SN₁ value to calculate a first initialization vector IV₁, and decrypt an encrypted first data packet according to the calculated IV₁ and a key; incrementally update a serial number SN₂ value initialized by the node 2, and perform second mathematical transformation on an updated SN₂ value to calculate a second initialization vector IV₂; and encrypt a second data packet according to the calculated IV₂ and the key, and then send an encrypted second data packet to the node 1, where the first mathematical transformation and the second mathematical transformation cause the calculated IV₁ to be unequal to the calculated IV₂.

Optionally, before calculating the first initialization vector IV₁, the processor is further configured to: determine an overflow sequence of SN₁ and IV₁; perform the first mathematical transformation on the acquired SN₁ value to calculate IV₁ when it is determined that SN₁ overflows firstly as follows: setting the SN₁ value configured to calculate IV₁ as a first dynamic parameter, multiply the first dynamic parameter by a coefficient P, and then summing a product of the first dynamic parameter and the coefficient P, a differentiation parameter C and a first parameter Q₁ to calculate IV₁; and perform the first mathematical transformation on the acquired SN₁ value to calculate IV when it is determined that IV₁ overflows firstly as follows: dividing the SN₁ value configured to calculate IV₁ by M for complementation to obtain a third dynamic parameter, multiply the third dynamic parameter by the coefficient P, and then summing a product of the third dynamic parameter and the coefficient P, the differentiation parameter C and Q₁ to calculate IV₁, where P is unequal to 1 and 0, and Q₁ is 0 or is not an integer multiple of P; and a length of C is equal to a length n of IV₁, C includes higher-order bits of k bits and lower-order bits of n−k bits, a value of the lower-order bits is zero, and M is a maximum value 2^{n-k} of lower-order n−k bits of IV₁ when IV₁ overflows firstly.

Optionally, the processor determines the overflow sequence of SN₁ and IV₁ as follows: calculating a difference between the length n of IV₁ and a length k of the higher-order bits; determining SN₁ to overflow firstly under the condition that a length m of SN₁ is not greater than the difference; and determining IV₁ to overflow firstly under the condition that the length m of SN₁ is greater than the difference.

Optionally, before calculating the second initialization vector IV₂, the processor is further configured to: determine an overflow sequence of SN₂ and IV₂; perform the second mathematical transformation on the updated SN₂ value to calculate SN₂ when it is determined that SN₂ overflows firstly as follows: setting the SN₂ value configured to calculate IV₂ as a second dynamic parameter, multiply the second dynamic parameter by the coefficient P, and then summing a product of the second dynamic parameter and the coefficient P, the differentiation parameter C and a second parameter Q₂ to calculate IV₂; and perform the second mathematical transformation on the updated SN₂ value to calculate IV₂ when it is determined that IV₂ overflows firstly as follows: dividing the SN₂ value configured to calculate IV₂ by M for complementation to obtain a fourth dynamic parameter, multiply the fourth dynamic parameter by the coefficient P, and then summing a product of the fourth dynamic parameter and the coefficient P, the differentiation parameter C and Q₂ to calculate IV₂, where Q₂ is 0 or is not an integer multiple of P, and is different from Q₁; and a length of C is equal to a length n of IV₂, and M is a maximum value 2^{n-k} of lower-order n−k bits of IV₂ when IV₂ overflows firstly.

Optionally, the processor determines the overflow sequence of SN₂ and IV₂ as follows: calculating a difference between the length n of IV₂ and a length k of the higher-order bits; determining SN₂ to overflow firstly under the condition that a length m of SN₂ is not greater than the difference; and determining IV₂ to overflow firstly under the condition that the length m of SN₂ is greater than the difference.

Optionally, before calculating the first initialization vector IV₁, the processor is further configured to: start an updating operation for the key when it is determined that SN₁ overflows firstly and the first dynamic parameter reaches a first preset threshold, and use an updated new key as a key used during data sending when the first dynamic parameter reaches a second preset threshold, where the first preset threshold is less than the second preset threshold, and the second preset threshold is not greater than a maximum value of SN₁; and start an updating operation for the key when it is determined that IV₁ overflows firstly and the third dynamic parameter reaches a third preset threshold, and use an updated new key as a key used during data sending when the third dynamic parameter reaches a fourth preset threshold, where the third preset threshold is less than the fourth preset threshold, and the fourth preset threshold is not greater than a maximum value of lower-order n−k bits of IV₁.

Optionally, before calculating the second initialization vector IV₂, the processor is further configured to: start an updating operation for the key when it is determined that SN₂ overflows firstly and the second dynamic parameter reaches a first preset threshold, and use an updated new key as a key used during data sending when the second dynamic parameter reaches a second preset threshold, where the first preset threshold is less than the second preset threshold, and the second preset threshold is not greater than a maximum value of SN₂; and start an updating operation for the key when it is determined that IV₂ overflows firstly and the fourth dynamic parameter reaches a third preset threshold, and use an updated new key as a key used during data sending when the fourth dynamic parameter reaches a fourth preset threshold, where the third preset threshold is less than the fourth preset threshold, and the fourth preset threshold is not greater than a maximum value of lower-order n−k bits of IV₂.

Optionally, when starting the updating operation for the key, the processor is further configured to: start a calculation operation of a new value of a number k of bits of the higher-order bits to generate a new differentiation parameter C; or, start a calculation operation of a new value N of the higher-order bits of the k bits to generate a new differentiation parameter C.

Optionally, when using the updated new key as a key used during data sending, the processor is further configured to: calculate an initialization vector (IV) used during data sending according to the new differentiation parameter C.

Optionally, P is set as 2, Q₁ is set as 0, Q₂ is set as −1, and C is set as a random number.

The present application further provides a computer program medium. The computer program medium stores a computer program, where when the computer program is executed by a processor, steps of a method for data secure transmission at a side of a node 1 or node 2 according to the embodiment above is implemented.

In the several embodiments according to the present application, it should be understood that the systems, apparatuses and methods disclosed can be implemented in other ways. For example, the apparatus embodiment described above is merely schematic. For example, division of the modules is merely a kind of division of logic functions, and there may be other division modes in actual implementation. For example, a plurality of modules or components can be combined or integrated into another system, or some features can be omitted or not conducted. In another aspect, the coupling or direct coupling or communicative connection to one another shown or discussed may be by means of some interfaces, and the indirect coupling or communicative connection of apparatuses or modules may be in electrical, mechanical, or other form.

The module described as a separable part may be physically separated or not, and a part shown as a module may be a physical unit or not, that is, may be located at one place or may also be distributed on a plurality of network modules. Some or all of the modules may be selected according to actual needs to achieve the purpose of the solution of the embodiment.

In addition, the functional modules in the embodiments of the present application may be integrated into the same processing module, or each module may be physically present separately, or two or more modules may be integrated into the same module. The above integrated modules may be implemented in the form of hardware, or may be implemented in the form of a software functional module. If the integrated modules are implemented in the form of software function modules and sold or used as independent products, the integrated modules may be stored in a computer-readable storage medium.

In the above embodiment, the integrated modules may be fully or partially implemented through software, hardware, firmware, or any combination of the software, the hardware and the firmware. When implemented by using software, the integrated modules may be fully or partially implemented in the form of a computer program product.

The computer program product includes one or more computer instructions. The flows or functions according to the embodiments of the present application are fully or partially generated when the computer program instructions are loaded or executed on a computer. The computer may be a general-purpose computer, a special-purpose computer, a computer network, or other programmable apparatuses. The computer instructions may be stored in a computer-readable storage medium or transmitted from one computer-readable storage medium to another computer-readable storage medium. For example, the computer instructions may be transmitted from one website, computer, server, or data center to the other website, computer, server, or data center in a wired (such as a coaxial cable, a fiber optic and a digital subscriber line (DSL)) or wireless (such as infrared, wireless and microwave) mode. The computer-readable storage medium may be any available medium that may be stored by a computer or a data storage device such as a server, a data center, etc. that includes one or more available media. The available medium may be a magnetic medium (such as a floppy disk, a hard disk and a magnetic tape), an optical medium (such as a digital video disk (DVDs)), or a semiconductor medium (such as a solid state disk (SSD)).

The technical solutions according to the present application are introduced in detail above. Specific examples are used in the present application for illustration of the principles and implementations of the present application. The description of the above embodiments is merely used to help understand the method and its core concept of the present application. In addition, a common person skilled in the art can make modifications to the specific implementations and application scope in accordance with the concept of the present application. To sum up, the content of the description should not be construed as a limitation to the present application.

Those skilled in the art should understand that the embodiments of the present application can be provided as methods, systems, or computer program products. Therefore, the present application can use full hardware embodiments, full software embodiments, or software and hardware combined embodiments. Moreover, the present application can take the form of a computer program product implemented on one or more computer usable storage media (including, but not limited to, disk memories, compact disc read-only memories (CD-ROMs), optical memories, etc.) containing computer usable program codes.

The present application is described with reference to flowcharts and/or block diagrams of methods, devices (systems), and computer program products according to the embodiments of the present application. It should be understood that each flow and/or block in the flow charts and/or block diagrams and combinations of the flows and/or blocks in the flow charts and/or block diagrams can be implemented by computer program instructions. These computer program instructions can be provided for a general-purpose computer, a special-purpose computer, an embedded processor, or a processor of another programmable data processing terminal device to generate a machine, such that the instructions executed by the computer or the processor of another programmable data processing terminal device generate an apparatus for implementing a specific function in one or more processes in the flow charts and/or in one or more blocks in the block diagrams.

These computer program instructions can also be stored in a computer-readable memory that may instruct the computer or another programmable data processing terminal device to work in a specific manner, such that the instructions stored in the computer-readable memory generate an artifact that includes an instruction apparatus. The instruction apparatus implements a specific function in one or more flows in the flow charts and/or in one or more blocks in the block diagrams.

These computer program instructions can also be loaded onto the computer or another programmable data processing terminal device, such that a series of operation steps are executed on the computer or another programmable data processing terminal device, so as to generate computer-implemented processing. Therefore, the instructions executed on the computer or another programmable data processing terminal device provide steps for implementing a specific function in one or more flows in the flow charts and/or in one or more blocks in the block diagrams.

Apparently, those skilled in the art can make various modifications and variations to the present application without departing from the spirit and scope of the present application. In this way, if these modifications and variations of the present application fall within the scope of the claims of the present application and their equivalent technologies, the present application is also intended to cover these modifications and variations.

1. A method for data secure transmission, comprising:
incrementally updating, by a node 1, a serial number SN₁ value initialized by the node 1, and performing, by the node 1, first mathematical transformation on an updated SN₁ value to calculate a first initialization vector IV₁;
encrypting, by the node 1, a first data packet according to the calculated IV₁ and a key, and then sending, by the node 1, an encrypted first data packet to a node 2;
acquiring, by the node 2, the SN₁ value in the received first data packet, performing, by the node 2, the first mathematical transformation on the acquired SN₁ value to calculate IV₁, and decrypting, by the node 2, the encrypted first data packet according to the calculated IV₁ and the key;
incrementally updating, by the node 2, a serial number SN₂ value initialized by the node 2, and performing, by the node 2, second mathematical transformation on an updated SN₂ value to calculate a second initialization vector IV₂;
encrypting, by the node 2, a second data packet according to the calculated IV₂ and the key, and then sending, by the node 2, an encrypted second data packet to the node 1; and
acquiring, by the node 1, the SN₂ value in the received second data packet, performing, by the node 1, the second mathematical transformation on the acquired SN₂ value to calculate IV₂, and decrypting, by the node 1, the encrypted second data packet according to the calculated IV₂ and the key;
wherein the first mathematical transformation and the second mathematical transformation cause the calculated IV₁ to be unequal to the calculated IV₂.

2. The method according to claim 1, wherein before the node 1/node 2 calculates the first initialization vector IV₁, the method further comprises:
determining an overflow sequence of SN₁ and IV₁;
performing the first mathematical transformation on the updated/acquired SN₁ value to calculate IV₁ when it is determined that SN₁ overflows firstly as follows:
setting the SN₁ value configured to calculate IV₁ as a first dynamic parameter, multiplying the first dynamic parameter by a coefficient P, and then summing a product of the first dynamic parameter and the coefficient P, a differentiation parameter C and a first parameter Q₁ to calculate IV₁; and
performing the first mathematical transformation on the updated/acquired SN₁ value to calculate IV₁ when it is determined that IV₁ overflows firstly as follows:
dividing the SN₁ value configured to calculate IV₁ by M for complementation to obtain a third dynamic parameter, multiplying the third dynamic parameter by the coefficient P, and then summing a product of the third dynamic parameter and the coefficient P, the differentiation parameter C and Q₁ to calculate IV₁;
wherein P is unequal to 1 and 0, and Q₁ is 0 or is not an integer multiple of P; and a length of C is equal to a length n of IV₁, C comprises higher-order bits of k bits and lower-order bits of n−k bits, a value of the lower-order bits is zero, and M is a maximum value 2^{n-k} of lower-order n−k bits of IV₁ when IV₁ overflows firstly.

3. (canceled)

4. The method according to claim 2, wherein before the node 2/node 1 calculates the second initialization vector IV2, the method further comprises:
determining an overflow sequence of SN2 and IV2;
performing the second mathematical transformation on the updated/acquired SN2 value to calculate IV2 when it is determined that SN2 overflows firstly as follows:
setting the SN2 value configured to calculate IV2 as a second dynamic parameter, multiplying the second dynamic parameter by the coefficient P, and then summing a product of the second dynamic parameter and the coefficient P, the differentiation parameter C and a second parameter Q2 to calculate IV2; and
performing the second mathematical transformation on the updated/acquired SN2 value to calculate IV₂ when it is determined that IV2 overflows firstly as follows:
dividing the SN2 value configured to calculate IV2 by M for complementation to obtain a fourth dynamic parameter, multiplying the fourth dynamic parameter by the coefficient P, and then summing a product of the fourth dynamic parameter and the coefficient P, the differentiation parameter C and Q2 to calculate IV2;
wherein Q2 is 0 or is not an integer multiple of P, and is different from Q1; and a length of C is equal to a length n of IV2, and M is a maximum value 2\hat{ }(n−k) of lower-order n−k bits of IV2 when IV2 overflows firstly.

5. (canceled)

6. The method according to claim 2, wherein before the node 1/node 2 calculates the first initialization vector IV1, the method further comprises:
starting an updating operation for the key when it is determined that SN1 overflows firstly and the first dynamic parameter reaches a first preset threshold, and using an updated new key as a key used during data sending when the first dynamic parameter reaches a second preset threshold, wherein the first preset threshold is less than the second preset threshold, and the second preset threshold is not greater than a maximum value of SN1; and
starting an updating operation for the key when it is determined that IV1 overflows firstly and the third dynamic parameter reaches a third preset threshold, and using an updated new key as a key used during data sending when the third dynamic parameter reaches a fourth preset threshold, wherein the third preset threshold is less than the fourth preset threshold, and the fourth preset threshold is not greater than a maximum value of lower-order n−k bits of IV1.

7. The method according to claim 4, wherein before the node 2/node 1 calculates the second initialization vector IV2, the method further comprises:
starting an updating operation for the key when it is determined that SN2 overflows firstly and the second dynamic parameter reaches a first preset threshold, and using an updated new key as a key used during data sending when the second dynamic parameter reaches a second preset threshold, wherein the first preset threshold is less than the second preset threshold, and the second preset threshold is not greater than a maximum value of SN2; and
starting an updating operation for the key when it is determined that IV2 overflows firstly and the fourth dynamic parameter reaches a third preset threshold, and using an updated new key as a key used during data sending when the fourth dynamic parameter reaches a fourth preset threshold, wherein the third preset threshold is less than the fourth preset threshold, and the fourth preset threshold is not greater than a maximum value of lower-order n−k bits of IV2.

8. The method according to claim 6, wherein when starting the updating operation for the key, the method further comprises:
starting a calculation operation of a new value of a number k of bits of the higher-order bits to generate a new differentiation parameter C; or, starting a calculation operation of a new value N of the higher-order bits of the k bits to generate a new differentiation parameter C.

9. The method according to claim 8, wherein when using the updated new key as the key used during data sending, the method further comprises:
calculating an initialization vector (IV) used during data sending according to the new differentiation parameter C.

10. The method according to claim 4, wherein P is set as 2, Q1 is set as 0, Q2 is set as −1, and C is set as a random number.

11. (canceled)

12. An apparatus for data secure transmission, comprising a memory and a processor, wherein the memory is configured to store a computer program; and the processor is configured to read the computer program in the memory to:
incrementally update a serial number SN1 value initialized by the apparatus, and perform first mathematical transformation on an updated SN1 value to calculate a first initialization vector IV1;
encrypt a first data packet according to the calculated IV1 and a key, and then send an encrypted first data packet to a node 2; and
acquire an SN2 value in a received second data packet, perform second mathematical transformation on the acquired SN2 value to calculate a second initialization vector IV2, and decrypt an encrypted second data packet according to the calculated IV2 and the key;
wherein the first mathematical transformation and the second mathematical transformation cause the calculated IV1 to be unequal to the calculated IV2.

13. The apparatus according to claim 12, wherein before calculating the first initialization vector IV1, the processor is further configured to read the computer program in the memory to:
determine an overflow sequence of SN1 and IV1;
perform the first mathematical transformation on the updated SN1 value to calculate IV1 when it is determined that SN1 overflows firstly as follows:
setting the SN1 value configured to calculate IV1 as a first dynamic parameter, multiplying the first dynamic parameter by a coefficient P, and then summing a product of the first dynamic parameter and the coefficient P, a differentiation parameter C and a first parameter Q1 to calculate IV1; and
perform the first mathematical transformation on the updated SN1 value to calculate IV1 when it is determined that IV1 overflows firstly as follows:
dividing the SN1 value configured to calculate IV1 by M for complementation to obtain a third dynamic parameter, multiplying the third dynamic parameter by the coefficient P, and then summing a product of the third dynamic parameter and the coefficient P, the differentiation parameter C and Q1 to calculate IV1;
wherein P is unequal to 1 and 0, and Q1 is 0 or is not an integer multiple of P; and a length of C is equal to a length n of IV1, C comprises higher-order bits of k bits and lower-order bits of n−k bits, a value of the lower-order bits is zero, and M is a maximum value 2\hat{ }(n−k) of lower-order n−k bits of IV1 when IV1 overflows firstly.

14. (canceled)

15. The apparatus according to claim 13, wherein before calculating the second initialization vector IV2, the processor is further configured to read the computer program in the memory to:
determine an overflow sequence of SN2 and IV2;
perform the second mathematical transformation on the acquired SN2 value to calculate IV2 when it is determined that SN2 overflows firstly as follows:
setting the SN2 value configured to calculate IV2 as a second dynamic parameter, multiplying the second dynamic parameter by the coefficient P, and then summing a product of the second dynamic parameter and the coefficient P, the differentiation parameter C and a second parameter Q2 to calculate IV2; and
perform the second mathematical transformation on the acquired SN2 value to calculate IV2 when it is determined that IV2 overflows firstly as follows:
dividing the SN2 value configured to calculate IV2 by M for complementation to obtain a fourth dynamic parameter, multiplying the fourth dynamic parameter by the coefficient P, and then summing a product of the fourth dynamic parameter and the coefficient P, the differentiation parameter C and Q2 to calculate IV2;
wherein Q2 is 0 or is not an integer multiple of P, and is different from Q1; and a length of C is equal to a length n of IV2, and M is a maximum value 2\hat{ }(n−k) of lower-order n−k bits of IV2 when IV2 overflows firstly.

16. (canceled)

17. The apparatus according to claim 13, wherein before calculating the first initialization vector IV1, the processor is further configured to read the computer program in the memory to:
start an updating operation for the key when it is determined that SN1 overflows firstly and the first dynamic parameter reaches a first preset threshold, and use an updated new key as a key used during data sending when the first dynamic parameter reaches a second preset threshold, wherein the first preset threshold is less than the second preset threshold, and the second preset threshold is not greater than a maximum value of SN1; and
start an updating operation for the key when it is determined that IV1 overflows firstly and the third dynamic parameter reaches a third preset threshold, and use an updated new key as a key used during data sending when the third dynamic parameter reaches a fourth preset threshold, wherein the third preset threshold is less than the fourth preset threshold, and the fourth preset threshold is not greater than a maximum value of lower-order n−k bits of IV1.

18. The apparatus according to claim 15, wherein before calculating the second initialization vector IV2, the processor is further configured to read the computer program in the memory to:
start an updating operation for the key when it is determined that SN2 overflows firstly and the second dynamic parameter reaches a first preset threshold, and use an updated new key as a key used during data sending when the second dynamic parameter reaches a second preset threshold, wherein the first preset threshold is less than the second preset threshold, and the second preset threshold is not greater than a maximum value of SN2; and
start an updating operation for the key when it is determined that IV2 overflows firstly and the fourth dynamic parameter reaches a third preset threshold, and use an updated new key as a key used during data sending when the fourth dynamic parameter reaches a fourth preset threshold, wherein the third preset threshold is less than the fourth preset threshold, and the fourth preset threshold is not greater than a maximum value of lower-order n−k bits of IV2.

19. The apparatus according to claim 17, wherein when starting the updating operation for the key, the processor is further configured to read the computer program in the memory to:
start a calculation operation of a new value of a number k of bits of the higher-order bits to generate a new differentiation parameter C; or, start a calculation operation of a new value N of the higher-order bits of the k bits to generate a new differentiation parameter C.

20. The apparatus according to claim 19, wherein when using an updated new key as a key used during data sending, the processor is further configured to read the computer program in the memory to:
calculate an initialization vector (IV) used during data sending according to the new differentiation parameter C.

21. The apparatus according to claim 15, wherein P is set as 2, Q1 is set as 0, Q2 is set as −1, and C is set as a random number.

22. An apparatus for data secure transmission, comprising a memory and a processor, wherein the memory is configured to store a computer program; and the processor is configured to read the computer program in the memory to:
acquire an SN1 value in a received first data packet, perform first mathematical transformation on the acquired SN1 value to calculate a first initialization vector IV1, and decrypt an encrypted first data packet according to the calculated IV1 and a key;
incrementally update a serial number SN2 value initialized by the apparatus, and perform second mathematical transformation on an updated SN2 value to calculate a second initialization vector IV2; and
a second encryption unit, configured to encrypt a second data packet according to the calculated IV2 and the key, and then send an encrypted second data packet to a node 1;
wherein the first mathematical transformation and the second mathematical transformation cause the calculated IV1 to be unequal to the calculated IV2.

23-32. (canceled)

33. The method according to claim 7, wherein when starting the updating operation for the key, the method further comprises:
starting a calculation operation of a new value of a number k of bits of the higher-order bits to generate a new differentiation parameter C; or, starting a calculation operation of a new value N of the higher-order bits of the k bits to generate a new differentiation parameter C.

34. The apparatus according to claim 18, wherein when starting the updating operation for the key, the processor is further configured to read the computer program in the memory to:
start a calculation operation of a new value of a number k of bits of the higher-order bits to generate a new differentiation parameter C; or, start a calculation operation of a new value N of the higher-order bits of the k bits to generate a new differentiation parameter C.
